(19) United States
(12) Patent Application Publication
(10) Pub. No.: US 2008/0147332 A1
(43) Pub. Date: Jun. 19, 2008

(54) System for and method of fluid delivery, monitoring and/or mangement

(76) Inventor: Muralidharan P. Arikara, Folsom, CA (US)

Correspondence Address: NEIL STEINBERG, 2300 M STREET, N.W., Suite 800, WASHINGTON, DC, 20037, US

(21) Appl. No.: 12/001,898

(22) Filed: Dec. 13, 2007

Related U.S. Application Data
(60) Provisional application No. 60/874,794, filed on Dec. 14, 2006.

(51) Int. Cl. G01N 31/00

(52) U.S. Cl. 702/23

(57) ABSTRACT

There are many inventions described and illustrated herein. In one aspect, the inventions relate to a system and method to monitor, control, manage and/or measure the delivery of one or more fluids (for example, liquid, gas and/or gas vapor forms of oxygen, nitrogen, carbon dioxide, hydrogen, and/or propane) from a fluid storage unit (whether mobile (for example, portable and/or transportable between a plurality of locations) or immobile (for example, permanently or semi-permanently fixed in a predetermined location)). In another aspect, the present inventions relate to a system and method to fill, refill, distribute, allocate and/or dispense fluid to one or more such fluid storage units (which contain or are capable of containing one or more such fluids).

### CROSS-REFERENCE TO RELATED APPLICATIONS

This application claims priority to U.S. Provisional Application Ser. No. 60/874,794, entitled “System for and Method of Fluid Delivery, Monitoring and/or Management”, filed Dec. 14, 2006. The contents of this Provisional Application are incorporated by reference herein in their entirety.

### BACKGROUND

In one aspect, the inventions relate to a system and method to monitor, control, manage and/or measure the delivery of one or more fluids (for example, liquid, gas and/or gas vapor forms of oxygen, nitrogen, carbon dioxide, hydrogen, and/or propane) from a fluid storage unit (whether mobile (for example, portable and/or transportable between a plurality of locations) or immobile (for example, permanently or semi-permanently fixed in a predetermined location)). In another aspect, the present inventions relate to a system and method to fill, refill, distribute, allocate and/or dispense fluid to one or more such fluid storage units (which contain or are capable of containing one or more such fluids).

### SUMMARY OF THE INVENTIONS

There are many inventions described and illustrated herein. The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, many of those permutations and combinations will not be discussed separately herein.

In one aspect, the present inventions (as initially claimed in this particular application) are directed to a system to monitor, control and/or manage the output of at least one fluid, the system comprises a first fluid storage unit including a first fluid container to store a fluid and a first interface unit, secured to the first fluid storage unit, to monitor the amount of fluid in the first fluid container, and a monitoring unit electrically coupled to the first interface unit and fluidically coupled to the first fluid storage unit to receive and output the fluid contained therein. The first interface unit comprises an electrical interface, memory to store data which is representative of (i) the type of fluid in the first fluid container and (ii) the amount of fluid in the first fluid container, and circuitry to monitor the amount of fluid in the first fluid container. The monitoring unit comprises a fluid interface coupled to the fluid interface of the first fluid storage unit, an electrical interface coupled to the electrical interface of the first interface unit to receive data which is representative of an amount of fluid in the first fluid container, and circuitry to communicate to a remote location data which is representative of (i) the physical location of first fluid storage unit and (ii) the amount of fluid in the first fluid container.

In one embodiment, the first interface unit includes a display to the amount of fluid in the first fluid container. The first interface unit may further include a user/operator input.

The electrical interface of the monitoring unit, in another embodiment, receives data which is representative of the type of fluid in the first fluid container; and the circuitry in the monitoring unit, using the data which is representative of the type of fluid in the first fluid container, evaluates whether to output fluid.

In one embodiment, the system may further include a second fluid storage unit including a second fluid container to store a fluid wherein the second fluid storage unit is coupled to the first interface unit. In addition, the memory of the first interface unit stores data which is representative of (i) the type of fluid in the second fluid container and (ii) the amount of fluid in the second fluid container, and the circuitry of the first interface unit monitors the amount of fluid in the second fluid container.

The monitoring unit of this embodiment may include a display to the amount of fluid in the second fluid container. The monitoring unit may also include a user/operator input to control the monitoring unit.

In another embodiment, the system further includes a second fluid storage unit including a second fluid container to store a fluid. The system of this embodiment may include a second interface unit, secured to the second fluid storage unit, to monitor the amount of fluid in the second fluid container. The second interface unit comprises an electrical interface, memory to store data which is representative of (i) the type of fluid in the second fluid container and (ii) the amount of fluid in the second fluid container, and circuitry to monitor the amount of fluid in the second fluid container. The monitoring unit is fluidically coupled to the second fluid storage unit to receive and output the fluid contained therein, the electrical interface is coupled to the electrical interface of the second interface unit to receive data which is representative of an amount of fluid in the second fluid container, and the circuitry communicates to a remote location data which is representative of (i) the physical location of second fluid storage unit and (ii) the amount of fluid in the second fluid container.

The monitoring unit of this embodiment may include a display to the amount of fluid in the second fluid container. The monitoring unit may also include a user/operator input to control the monitoring unit.

In another principal aspect, the present inventions are directed to a system to monitor, control and/or manage the output of a fluid; the system comprises a first fluid storage unit including a first fluid container to store a fluid, a first interface unit, and a monitoring unit. The first interface unit is secured to the first fluid storage unit and comprises an electrical interface, and memory to store data which is representative of (i) the type of fluid in the first fluid container and (ii) the amount of fluid in the first fluid container. The monitoring unit is fluidically coupled to the first fluid storage unit to receive and output the fluid contained therein. The monitoring unit comprises a fluid interface coupled to the fluid interface of the first fluid storage unit, an electrical interface coupled to the electrical interface of the first interface unit to receive data which is representative of the amount of fluid in the first fluid container, circuitry to monitor the amount of fluid in the first fluid container, and circuitry to communicate to a remote location data which is representative of (i) the physical location of first fluid storage unit and (ii) the amount of fluid in the first fluid container.

In one embodiment, the first interface unit includes a display to the amount of fluid in the first fluid container. The first interface unit may further include a user/operator input.

In another embodiment, the circuitry in the monitoring unit stores data which is representative of the amount of fluid in the first fluid container in the memory of the first interface unit.

In one embodiment, the electrical interface of the monitoring unit may receive data which is representative of the type of fluid in the first fluid container and the circuitry in the monitoring unit, using the data which is representative of the type of fluid in the first fluid container, evaluates whether to output fluid.

The system may include a second fluid storage unit including a second fluid container to store a fluid wherein the second fluid storage unit is coupled to the first interface unit. The memory of the first interface unit may store data which is representative of (i) the type of fluid in the second fluid container and (ii) the amount of fluid in the second fluid container. The monitoring unit of this embodiment may include a display to the amount of fluid in the first fluid container. The monitoring unit may also include a user/operator input to control the monitoring unit.

In one embodiment the system may include a second fluid storage unit including a second fluid container to store a fluid and a second interface unit, secured to the second fluid storage unit, to monitor the amount of fluid in the second fluid container. The second interface unit may comprise an electrical interface, and memory to store data which is representative of (i) the type of fluid in the second fluid container and (ii) the amount of fluid in the second fluid container. The monitoring unit of this embodiment is fluidically coupled to the second fluid storage unit to receive and output the fluid contained therein. The electrical interface is coupled to the electrical interface of the second interface unit to receive data which is representative of an amount of fluid in the second fluid container, the circuitry monitors the amount of fluid in the second fluid container and the circuitry communicates to a remote location data which is representative of (i) the physical location of second fluid storage unit and (ii) the amount of fluid in the second fluid container.

The monitoring unit of this embodiment may include a display to the amount of fluid in the second fluid container. The monitoring unit may also include a user/operator input to control the monitoring unit.

Again, there are many inventions, and aspects of the inventions, described and illustrated herein. This Summary of the Inventions is not exhaustive of the scope of the present inventions; indeed, certain inventions described and/or illustrated herein may be protected and/or claimed via divisional and/or continuation applications. Moreover, this Summary of the Inventions is not intended to be limiting of the inventions and should not be interpreted in that manner. While certain embodiments have been described and/or outlined in this Summary of the Inventions, it should be understood that the present inventions are not limited to such embodiments, description and/or outline, nor are the claims limited in such a manner. Indeed, many others embodiments, which may be different from and/or similar to the embodiments presented in this Summary, will be apparent from the description, illustrations and claims, which follow. In addition, although various features, attributes and advantages have been described in this Summary of the Inventions and/or are apparent in light thereof, it should be understood that such features, attributes and advantages are not required whether in one, some or all of the embodiments of the present inventions and, indeed, need not be present in any of the embodiments of the present inventions.

### BRIEF DESCRIPTION OF THE DRAWINGS

In the course of the detailed description to follow, reference will be made to the attached drawings. These drawings show different aspects of the present inventions and, where appropriate, reference numerals illustrating like structures, components, materials and/or elements in different figures are labeled similarly. It is understood that various combinations of the structures, components, materials and/or elements, other than those illustrated, are contemplated and within the scope of the present inventions.

Moreover, there are many inventions described and illustrated herein. The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, many of those permutations and combinations will not be discussed or illustrated separately herein.

FIGS. 1A and 1B are block diagram representations of exemplary embodiments of systems to monitor, control, manage and/or measure the delivery of one or more fluids (for example, liquid, gas and/or gas vapor forms of oxygen, nitrogen, carbon dioxide, hydrogen, and/or propane) from a fluid storage unit, according to certain aspects of the present inventions;

FIGS. 2A and 2B are block diagram representations of exemplary mechanical, electrical and fluid interfaces of the interface unit facilitates mating with the monitoring unit (FIG. 2A) and the fluid storage unit (FIG. 2B) of the configuration of FIG. 1A;

FIG. 2C is a block diagram representation of the communication paths of the monitoring unit, the interface unit and the fluid storage unit;

FIG. 3A is an illustration of exemplary mechanical, electrical and fluid interfaces of the interface unit which includes a “twist-on” mechanical portion that facilitates mating with the fluid storage unit and/or monitoring unit;

FIG. 3B is an illustration of exemplary reciprocal mechanical, electrical and fluid interfaces to the interface of FIG. 3A;

FIGS. 4A-4C are block diagram representations of exemplary embodiments of systems to monitor, control, manage and/or measure the delivery of one or more fluids from one or more fluid storage units, according to certain configurations/embodiments and aspects of the present inventions;

FIGS. 5A and 5B are block diagram representations of exemplary monitoring units, according to certain embodiments of certain aspects of the present inventions;

FIGS. 6A-6D are block diagram representations of exemplary interface units, according to certain embodiments of certain aspects of the present inventions;

FIGS. 7A and 7B are block diagram representations of exemplary embodiments of systems to monitor, control, manage and/or measure the delivery of one or more fluids from one or more fluid storage units, according to certain configurations/embodiments and aspects of the present inventions;

FIG. 8A is a block diagram representation of exemplary mechanical, electrical and fluid interfaces of the interface unit facilitates mating with an external circuitry/device and the fluid storage unit (FIG. 2B);

FIG. 8B is a block diagram representation of the communication paths of the interface unit and the fluid storage unit of the configuration of FIGS. 1B and 8A;

FIGS. 9A and 9B are block diagram representations of exemplary embodiments of systems to monitor, control, manage and/or measure the delivery of one or more fluids from one or more fluid storage units wherein a plurality of interface units are coupled to a monitoring unit, according to certain configurations/embodiments and aspects of the present inventions;

FIGS. 10A-10E are block diagram representations of exemplary embodiments of systems to monitor, control, manage and/or measure the delivery of one or more fluids from one or more fluid storage units wherein an interface unit is coupled to and receives fluid from a plurality of fluid storage units, according to certain configurations/embodiments and aspects of the present inventions;

FIGS. 11A and 11B are block diagram representations of exemplary embodiments of systems to monitor, control, manage and/or measure the delivery of one or more fluids from one or more fluid storage units wherein an interface unit is coupled to a plurality of monitoring units and one or more fluid storage units, according to certain configurations/embodiments and aspects of the present inventions;

FIGS. 12A and 12B are block diagram representations of exemplary embodiments of systems to monitor, control, manage and/or measure the delivery of a plurality of the same or different fluids (for example, liquid, gas and/or gas vapor forms of oxygen, nitrogen, carbon dioxide, hydrogen, and/or propane) from one or more fluid storage units, according to certain aspects of the present inventions;

FIGS. 13A-13C are block diagram representations of exemplary embodiments of systems to monitor, control, manage and/or measure the delivery of one or more fluids from one or more fluid storage units wherein an interface unit may be coupled directly to external circuitry, according to certain configurations/embodiments and aspects of the present inventions;

FIGS. 14A-14G are block diagram representations of exemplary fluid manifold units which outputs fluid from one or more fluid storage units, according to certain aspects of the present inventions; notably, in certain embodiments, the fluid manifold unit is disposed in the interface unit and/or the monitoring unit;

FIGS. 15A-15D are block diagram representations of exemplary embodiments of systems to fill or refill the one or more fluid storage units, according to certain configurations/embodiments and aspects of the present inventions;

FIG. 16A is a block diagram representation of the communication paths of the refill station unit, the interface unit and the fluid storage unit;

FIG. 16B is a block diagram representation of the communication paths of the refill station unit and the fluid storage unit;

FIGS. 17A-17D are block diagram representations of exemplary refill station units, according to certain embodiments of certain aspects of the present inventions;

FIG. 18A is a block diagram representation of an exemplary embodiment of a system to monitor, control, manage and/or measure the delivery of one or more fluids from a plurality of fluid storage units, each of which is associated with an interface unit wherein data which is representative of one or more operating parameters of each fluid storage unit and/or associated interface unit is provided to a local and/or central station, according to certain configurations/embodiments and aspects of the present inventions;

FIG. 18B is a block diagram representation of an exemplary embodiment of a system to monitor, control, manage and/or measure the delivery of a fluid from a fluid storage unit wherein the interface unit does not include a display, according to a configuration/embodiment and aspect of the present inventions;

FIG. 19 is a block diagram representation of an exemplary embodiment of a technique for controlling and/or monitoring the delivery of a fluid using one or more regulators, actuators and/or sensors, according to a configuration/embodiment and aspect of the present inventions;

FIGS. 20A, 20C 21A and 21C are block diagram representations of communication configurations of the monitoring unit, interface unit and the fluid storage unit; and

FIGS. 20B, 20D, 21B and 21D are block diagram representations of communication configurations of the refill station unit, interface unit and fluid storage unit.

Again, there are many inventions described and illustrated herein. The present inventions are neither limited to any single aspect nor embodiment thereof, nor to any combinations and/or permutations of such aspects and/or embodiments. Each of the aspects of the present inventions, and/or embodiments thereof, may be employed alone or in combination with one or more of the other aspects of the present inventions and/or embodiments thereof. For the sake of brevity, many of those combinations and permutations are not discussed separately herein.

### DESCRIPTION OF THE INVENTIONS

There are many inventions described and illustrated herein as well as many embodiments thereof. In one aspect, the present inventions are directed to a system and method to monitor, control, manage and/or measure the delivery of one or more fluids (for example, liquid, gas and/or gas vapor forms of oxygen, nitrogen, carbon dioxide, hydrogen, and/or propane) from a fluid storage unit (whether mobile (for example, portable and/or transportable between a plurality of locations) or immobile (for example, permanently or semi-permanently fixed in a predetermined location)). In another aspect, the present inventions relate to a system and method to fill, refill, distribute, allocate and/or dispense fluid to one or more such fluid storage units (which contain or are capable of containing one or more such fluids).

In one exemplary embodiment, the present inventions include (1) a monitoring unit to monitor, control, manage and/or measure the delivery and/or flow of fluid from a mobile fluid storage unit (for example, a conventional size gas bottle or cylinder such as K-bottle size tank), and (2) an interface unit having: (i) fluid and mechanical interfaces coupled between the mobile fluid storage unit and the monitoring unit, and (ii) an electrical interface coupled to the monitoring unit. As such, in this embodiment, the monitoring unit mechanically, fluidically and electrically mates and/or couples to the interface unit; and the interface unit mechanically and fluidically mates and/or couples to the mobile fluid storage unit. The monitoring unit outputs or provides the fluid to the user/operator and/or one or more external devices coupled to the monitoring unit to receive the fluid.

In addition, the monitoring unit may output or provide data which is representative of one or more operating parameters or conditions (hereinafter collectively “parameters”) of the fluid storage unit to external circuitry (for example, circuitry located at a local station, central station and/or fluid supplier, and/or circuitry of the user/operator (whether such user/operator is located locally or remotely)). The operating parameters may be, for example, the amount of fluid remaining in the storage unit, the amount of fluid dispensed, the rate of fluid consumption, the rate of flow of fluid, the time (or estimation thereof) remaining until all (or a predetermined amount) of the fluid is dispensed, and/or any malfunctions or faults (for example, a fluid leak, mechanical, electrical and/or electronic interface fault) of the system, or components, elements and/or subsystems thereof.

The monitoring unit may also output or provide data which is representative of the physical location of the monitoring unit, interface unit and/or fuel storage unit. As such, the monitoring unit or the interface unit may include circuitry (RFID, GPS or the like) to provide for example, a local station, central station, fluid supplier, and/or user/operator (whether such user/operator is located locally or remotely), the physical location of one or more of the monitoring unit, interface unit and/or fuel storage unit. Such circuitry may correlate the data with mapping-type software to illustrate the physical location. In one embodiment, circuitry (whether located locally or remotely from the monitoring unit, interface unit and/or fuel storage unit) may determine, schedule, plan and/or calculate a route or schedule for the delivery of new fluid storage units to replenish the consumed units and/or route the filling vehicle to fill the fluid storage units that are relatively fixed.

In one embodiment, the monitoring unit may include and/or employ any sensing and/or measuring technique and/or device (for example, one or more flow meters to measure and/or determine the rate of flow of fluid, clock circuitry, temperature and/or pressure data provided by sensors disposed on/in and/or associated with the fluid storage unit). The monitoring unit may also include circuitry (for example, a microprocessor, microcontroller, state machine, discrete logic, and/or programmable gate array (for example, field programmable gate array)) to calculate and/or determine data which is representative of the one or more operating parameters. Moreover, the monitoring unit may include memory (for example, dynamic or static memory (whether discrete or integrated with the circuitry) such as SRAM, DRAM, ROM, PROM, EPROM and/or EEPROM) to receive and store data or information which is representative of the one or more operating parameters (for example, current or historical type information). The memory may further receive and store data which uniquely identifies (from the perspective of one or more other storage units) the interface unit and/or the fluid storage unit. Notably, all forms or types of memory, whether now known or later developed, are intended to fall within the scope of the present inventions.

In one embodiment, the circuitry in the monitoring unit may further control, manage and/or measure the one or more operating parameters of the fluid storage unit and/or interface unit. Such circuitry may, in an intermittent, continuous, periodic on the occurrence of an event (whether an internal event or an external event) and/or at predetermined time, monitor, control, manage and/or measure the one or more operating parameters of the fluid storage unit and/or interface unit. The circuitry may employ or use data provided by/from any sensing and/or measuring technique and/or device, for example, a sensing or measuring device associated with the fluid storage unit and/or interface unit. The monitoring unit may provide the data which is representative of one or more operating parameters of the fluid storage unit and/or interface unit to external circuitry (for example, circuitry disposed at a remote location, such as, circuitry at a central station and/or fluid supplier/provider). Notably, the monitoring unit may provide the data via wired and/or wireless techniques.

Where data which is representative of one or more operating parameters of the fluid storage unit is provided to external circuitry located, for example, at a remote location, the system facilitates remote monitoring, controlling, tracking and/or managing thereof. For example, in the context of a hospital environment, a nurse or technician at a remote station may monitor one or more operating parameters of a fluid storage unit containing, for example, oxygen in a gas form. In this regard, the nurse or technician may monitor, from the remote station, the state of fill of the fluid storage unit, time (or estimation thereof) remaining until all (or a predetermined amount) of oxygen is dispensed, and/or any malfunctions or faults (for example, a leak, mechanical, electrical and/or electronic interface fault) of the system, or components, elements and/or subsystems thereof. Indeed, the remote station may provide/display data which is representative of one or more operating parameters of a plurality of fluid storage units (which may be, for example, located in one or more rooms located on the same or different floors).

Further, data which is representative of one or more operating parameters of one or more fluid storage units (which are, for example, located in one or more rooms on, for example, one, some or all floors) may be monitored, tracked, controlled and/or managed at a central location such as a central administrator or fluid supplier/provider. For example, a central location may monitor, track, control and/or manage the state of fill of the fluid storage unit and/or the time (or estimation thereof) remaining until all (or a predetermined amount) of oxygen is dispensed to monitor, manage and/or track inventory, including the supply and re-supply thereof. Moreover, such data may be compiled, ordered and/or organized to provide a representation of historical and/or current inventory, to address organization needs (for example, re-supply), and/or more effectively manage, monitor and/or track inventory of the fluid storage unit. In this way, certain resources (for example, manpower of the fluid supplier/provider and size of inventory) may be more efficiently and cost effectively managed by, for example, more effectively managing, monitoring and/or tracking inventory of the fluid storage unit at customer/user sites using features of the system and methods of the present inventions.

In addition to providing a “real-time” state of fill of the fluid storage unit, or in lieu thereof, the monitoring unit may notify (for example, via an audible or visual indicator) the remote circuitry (for example, in the context of a hospital, the nurse or technician at a local station and a central location such as a central administrator or fluid supplier/provider) upon dispensing all or nearly dispensing all of the fluid in the fluid storage unit. In response, the nurse or technician may change/replace the fluid storage unit. In addition, as noted above, a central location may monitor, track, control and/or manage such data to provide a representation of historical and/or current inventory, to address organization needs (for example, re-supply), and/or to more effectively manage, monitor and/or track inventory of the fluid storage unit. Again, in this way, resources (for example, manpower of the fluid supplier/provider and size of fluid storage unit inventory) may be more efficiently and cost effectively managed by more effectively managing, monitoring and/or tracking inventory of the fluid storage unit at customer/user sites using features of the system and methods of the present inventions.

Notably, a user/operator or external device may also control (for example, enable, disable, program and/or configure) the monitoring, management and/or control operation(s) of the monitoring unit of the fluid delivery, monitoring and management system. The user/operator or external device may employ wired and/or wireless techniques to communicate with the monitoring unit. The monitoring, managing and/or control process assigned to the monitoring unit may be fixed, preset, predetermined, pre-programmed, programmable and/or configurable (in situ or otherwise).

In one embodiment, a user/operator or external device may control (for example, enable, disable, program and/or configure) the operation(s) of the monitoring unit locally and/or directly using a user/operator interface disposed on or associated with the monitoring unit. In this regard, the monitoring unit may include a user/operator interface having a user/operator input mechanism (for example, one or more button switches and/or a keypad) which allows the user/operator to input data, commands and/or instructions. In this way, the user/operator may locally control and/or manage the system (for example, the monitoring unit, interface unit and/or mobile fluid storage unit). In addition thereto, or in lieu thereof, the monitoring unit may include an input/output connector and/or transmitter/receiver to facilitate wired and/or wireless interconnection with a local external device (for example, a computer or PDA).

In addition, the user/operator interface may include a visual and/or audible indicator. The visual and/or audible indicator may provide information regarding one or more of the operating parameters of the monitoring unit, interface unit and/or fluid storage unit. For example, the monitoring unit may include a display (for example, an LCD or LED display) to visually display information which is representative of one or more of the operating parameters of the fluid storage unit, monitoring unit and/or interface unit (for example, the amount of fluid remaining in the storage unit, the rate of fluid consumption, and the amount of time until a predetermined amount of fluid is consumed (such as totally consumed).

The monitoring unit may include a power source, for example, a battery or external power (e.g., 24V, 110V or 220V), to provide electrical power to the circuitry/devices of interface unit and/or monitoring unit. In one embodiment, the power source may be locally generated/provided (for example, via a battery and/or hydrogen fuel cell system). In addition thereto, or in lieu thereof, the power source may be and/or remotely generated/provided (for example, via the power grid). Indeed, any form of power as well as any technique and/or mechanism to provide power, whether now known or later developed, is intended to fall within the scope of the present inventions.

Notably, the monitoring unit may receive/obtain data which specifically or uniquely identifies the fluid storage unit. For example, such data may include an associated serial number, date of manufacture and/or assembly, data pertaining to the supplier of the interface/storage unit and/or of one or more components of the interface/storage unit, and/or data pertaining to the date of certification and/or recertification. The data may include the fluid storage capacity of the fluid storage unit, number of refills (if applicable) and dates thereof, revision or series of electronics/software of the interface unit, and/or type of fluid stored in the fluid storage unit, and/or certain “fixed” operating parameters thereof (for example, delivery/output pressure of the fluid). The data may further include data that more generally identifies the fluid storage unit and/or the interface (for example, model number). In this way, the monitoring unit may monitor, track, control and/or manage data which specifically or uniquely identifies a particular fluid storage unit and/or interface unit.

In one embodiment, the monitoring unit may monitor, control and/or manage the type of fluid stored in the fluid storage unit as well as certain operating parameters thereof (for example, the delivery/output pressure of the fluid). In this regard, the monitoring unit may receive the data which uniquely identifies the fluid storage unit, including the type of fluid stored in the fluid storage unit, certain “fixed” operating parameters thereof (for example, delivery/output pressure of the fluid) and/or data pertaining to the date of certification and/or recertification. Based thereon, in conjunction with the intended use of the fluid, the monitoring unit may determine whether to output the fluid to the user. For example, the monitoring unit may determine that the fluid storage unit contains a fluid (or outputs a pressure thereof) which is different from the fluid (or the pressure thereof) the user expects to receive. In addition thereto, or in lieu thereof, the monitoring unit may determine the storage unit must or should be recertified (which may cause the monitoring unit from not dispensing fluid from the storage unit).

In addition thereto, or in lieu thereof, the monitoring unit may monitor, control and/or manage the type of fluid delivered via a “unique” or “keyed” fluid interface (for example, a “unique” or “keyed” valve assembly). In this regard, the fluid interface on the interface unit and/or the fluid storage unit (for example, the valve assembly) may be representative of or indicative of the type of fluid stored in the fluid storage unit and/or certain operating parameters thereof (for example, the delivery/output pressure of the fluid). The fluid interface on the monitoring unit may include a mating assembly which is specific to one or more types of fluids. In this embodiment, the monitoring unit may detect/determine the type of fluid stored in the fluid storage unit via the “unique” or “keyed” fluid interface and, based on the intended use of the fluid, determine whether to output or provide the fluid to the user.

In another embodiment, the monitoring unit may also detect/determine the configuration of the system (for example, the existence or absence of certain components (such as a pressure regulator, mass flow controller, flow restriction values or the like) and/or the ratings and/or capabilities of the system components). In this embodiment, the monitoring unit may detect/determine certain “fixed” operating parameters of the fluid (for example, delivery/output pressure) and, based on the intended use of the fluid as well as the configuration of the system (as detected/determined), assess and/or evaluates whether to receive the fluid from the storage unit (or interface unit) and/or whether to output or provide the fluid to, for example, the user/operator. Moreover, based on the intended use of the fluid as well as the configuration of the system (as detected/determined), control and/or manage one or more components of the system (such as a pressure regulator, mass flow controller, flow restriction values or the like) such that the parameters (for example, pressure and fluid type/mixture) of the fluid output from the storage unit (or interface unit) and/or output from the monitoring unit to the user is suitable based on the intended use of the fluid.

Notably, the user/operator and/or an external device may also obtain data which uniquely identifies the fluid storage unit. In this way, user/operator and/or an external device (for example, at a remote central location) may generate information which is representative of historical and/or current inventory to, for example, address organization needs (for example, re-supply), and/or more effectively manage, monitor and/or track inventory of the fluid storage unit. The monitoring unit may provide data which uniquely identifies the fluid storage unit to the user/operator and/or external circuitry (for example, circuitry located remotely (for example, at a central station and/or fluid supplier/provider) via wired and/or wireless techniques. The monitoring unit may further provide data pertaining to when the fluid storage unit was certified and/or is to be or should have been recertified. Where the fluid storage unit is overdue with respect to recertification, the interface unit may take appropriate action including, for example, providing audible and visual alerts to the user/operator and/or prohibiting or preventing the fluid storage unit from dispensing fluid (and/or being filled with any of the fluids in the context of the refill station unit discussed below).

As noted above, the interface unit mechanically and fluidically mates and/or couples to the fluid storage unit. In one embodiment, the interface unit may be (permanently or temporarily) fixed to and associated with a particular fluid storage unit. In another embodiment, the interface unit may engage or disengage from the fluid storage unit. The interface unit includes suitable mechanical, electrical and fluid interfaces to interconnect with the monitoring unit and the fluid storage unit, which include a reciprocal or “mating” interface.

The interface unit may include circuitry (for example, a microprocessor, microcontroller, state machine, discrete logic, and/or programmable gate array (for example, field programmable gate array)) to calculate and/or determine data which is representative of the one or more operating parameters of the system and/or fluid storage unit. The interface unit may include circuitry which communicates and/or interacts with circuitry in the monitoring unit and/or circuitry of an external device. Moreover, the interface unit may include memory (for example, dynamic or static memory (whether discrete or integrated with the circuitry) such as SRAM, DRAM, ROM, PROM, EPROM and/or EEPROM) to receive and store data or information which is representative of the one or more operating parameters (for example, current or historical type information). The data or information which is representative of one or more operating parameters may include a current status and/or historical data (for example, temporally correlated data of one or more operating parameters). The memory may further receive and store data which uniquely identifies (from the perspective of one or more other storage units) the interface unit and/or the fluid storage unit. Notably, all forms or types of memory, whether now known or later developed, are intended to fall within the scope of the present inventions.

In one embodiment, the data or information which is representative of one or more operating parameters may be calculated and/or determined in the monitoring unit (as discussed above) and provided to the interface unit. In response to (or after) receiving data or information which is representative of one or more operating parameters from the monitoring unit, or calculation thereof in the interface unit, the memory in the interface unit may store such data or information. As such, the interface unit stores such data or information and, in the event of, for example, removal of the interface unit/storage unit from the monitoring unit and/or loss of electrical power (in those instances where the interface unit includes a non-volatile type memory or memory architecture), the data or information stored in the memory (for example, data or information which is representative of a status of one or more operating parameters) is “preserved”. Indeed, the data or information stored in the memory device may be representative of the current status of one or more operating parameters and/or historical data (for example, temporally correlated data of one or more operating parameters).

In addition to the monitoring unit calculating and/or determining data or information which is representative of one or more operating parameters of the interface unit and/or fluid storage unit (as discussed above), or in lieu thereof, the data or information which is representative of one or more operating parameters may be calculated and/or determined in the interface unit. In this embodiment, the interface unit may include processing circuitry (for example, a microprocessor, microcontroller, state machine, discrete logic, and/or programmable gate array (for example, field programmable gate array)) to calculate and/or determine data which is representative of the one or more operating parameters. As with the monitoring unit, the interface unit may include and/or employ any sensing and/or measuring technique and/or device (for example, one or more flow meters to measure and/or determine the rate of flow of fluid, clock circuitry, temperature and/or pressure data provided by sensors disposed on/in the fluid storage unit).

The interface unit may also output or provide data which is representative of the physical location of the interface unit and/or fuel storage unit. As such, the interface unit may include circuitry (RFID, GPS or the like) to provide for example, a local station, central station, fluid supplier, and/or user/operator (whether such user/operator is located locally or remotely), the physical location of one or more of the monitoring unit, interface unit and/or fuel storage unit. As noted above, such circuitry may correlate the data with mapping-type software to illustrate the physical location. In one embodiment, circuitry (whether located locally or remotely from the interface unit and/or fuel storage unit) may determine, schedule, plan and/or calculate a route or schedule for the delivery of new fluid storage units to replenish the consumed units and/or route the filling vehicle to fill the fluid storage units that are relatively fixed.

It should be noted that the memory in the interface unit may be include discrete component(s) or may reside on or in an integrated circuit that performs other non-memory operations, for example, processing circuitry (such as a microcontroller or microprocessor).

As noted above, the memory in the interface unit may also store and/or retain one or more “unique” attributes of the fluid storage unit. For example, the memory may store data that uniquely identifies the fluid storage unit (for example, an associated serial number, date of manufacture and/or assembly, data pertaining to the supplier of one or more components of the interface/storage unit, fluid storage capacity, number of refills (if applicable) and dates thereof, revision or series of electronics/software, data pertaining to the date of certification and/or recertification and/or type of fluid stored in the fluid storage unit) and/or more generally identifies the fluid storage unit and/or the interface (for example, model number).

The interface unit may also include a user/operator interface, for example, a display (for example, an LCD or LED display) to visually display information which is representative of one or more of the operating parameters of the fluid storage unit and/or the interface. In addition thereto, or in lieu thereof, the user/operator interface may include an audible indicator and/or an input mechanism (for example, one or more button switches or keypad) to receive user/operator inputs, data, commands and/or instructions. In addition, the interface unit may include a power source (for example, local power source such as a battery or fuel cell) or receive external power (e.g., 24V, 110V or 220V) to provide electrical power to the circuitry/devices of interface unit and/or monitoring unit.

Notably, the interface unit may visually and/or audibly provide data pertaining to when the fluid storage unit was certified and/or is to be or should have been recertified. Where the fluid storage unit is overdue with respect to recertification, the interface unit may take appropriate action including, for example, providing audible and visual alerts to the user/operator and/or prohibiting or preventing the fluid storage unit from dispensing fluid (and/or being filled with any of the fluids in the context of the refill station unit discussed below).

As noted above, the interface unit may include circuitry which communicates with circuitry of an external device (other than the monitoring unit). In one embodiment, the interface unit may provide data which is representative of one or more operating parameters of the fluid storage unit (for example, data which is stored in the memory device) to external circuitry located, for example, at a remote location, the system facilitates remote monitoring, controlling, tracking and/or managing thereof. The data may include current or historical data which is representative of one or more operating parameters (for example, “real-time” data or temporally correlated data of one or more operating parameters).

Notably, in one embodiment, the interface unit may directly receive inputs, data, commands and/or instructions from an external device. Such inputs, data, commands and/or instructions may be provided via wired and/or wireless interconnection with an external device.

Thus, the monitoring unit and/or interface unit may actively monitor, manage and/or control one or more operating parameter(s) of the system. For example, the monitoring unit and/or interface unit may monitor, manage and/or control the consumption and/or the rate of consumption of fluid, and in response thereto, may provide and/or alert the user to amount of fluid remaining, consumed, the rate of consumption and/or the time (or estimation thereof) remaining until all (or a predetermined amount) of the fluid is spent. In this way, the user/operator, as well as the fluid provider/supplier, may schedule or plan accordingly, including managing inventory of the fluid and/or fluid storage units.

Notably, the fluid storage unit may contain/store one or more pressurized or non-pressurized fluids. Such fluid(s) may be stored in, for example, solid, liquid, gas and/or gas vapor forms in, for example, a conventional size gas bottle or cylinder (such as a T- or K-bottle size cylinder) or a storage tank. The fluid storage unit may be mobile (for example, portable and/or transportable between a plurality of locations) or immobile (for example, permanently or semi-permanently fixed in a predetermined location). The fluid(s) may be, for example, oxygen, nitrogen, carbon dioxide, hydrogen, alcohol and/or propane. Where the fluid storage unit contains/stores a pressurized fluid it may be advantageous to employ a pressure regulator to establish and/or maintain a suitable, desired and/or predetermined delivery pressure of the fluid (in relation to the interface unit). Moreover, the monitoring unit and/or interface unit may include a mass flow controller that controls, provides and/or determines the rate of deliver of the fluid from the fluid storage unit. The pressure regulator and/or the mass flow controller may be electrically controllable which allows the monitoring unit and/or the interface unit to control the flow on a real time basis and/or in response to the operator/user request or instruction.

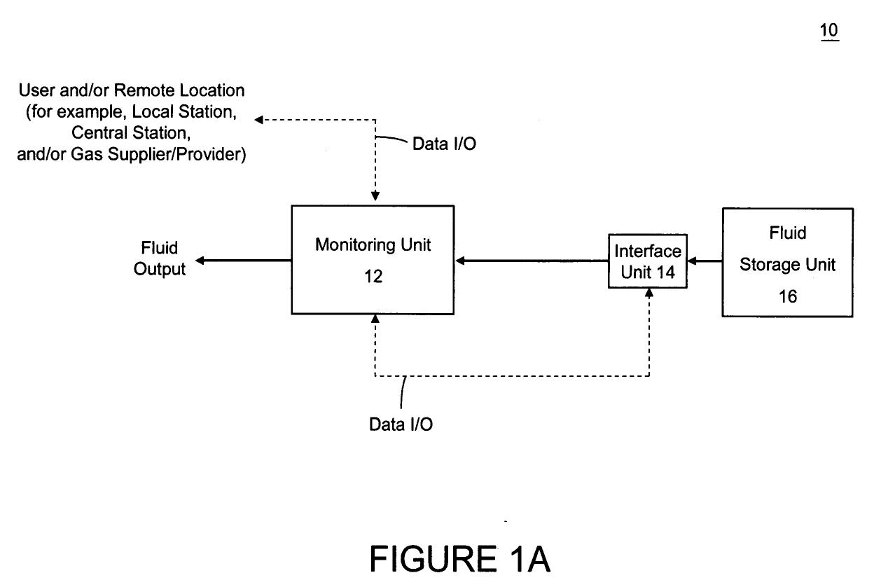

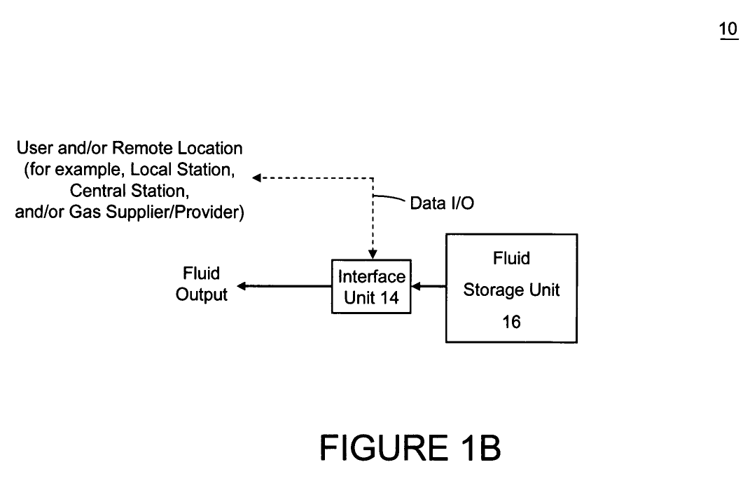

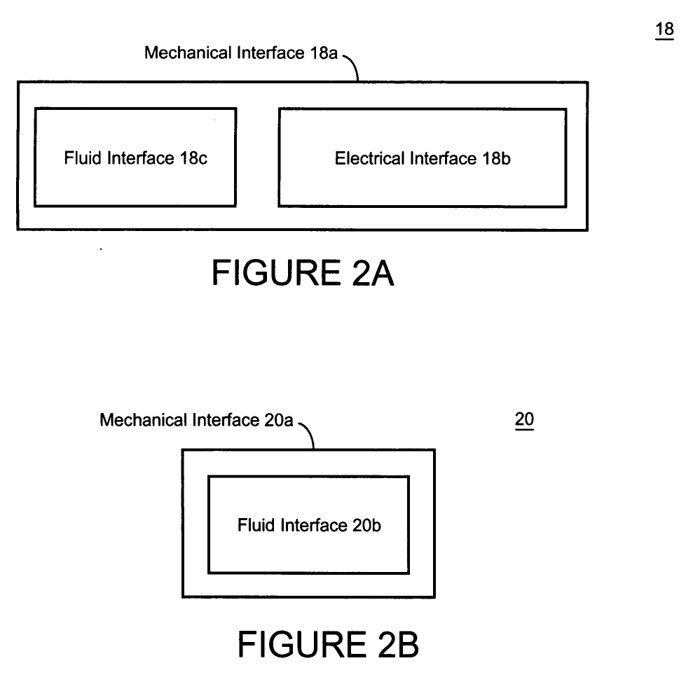

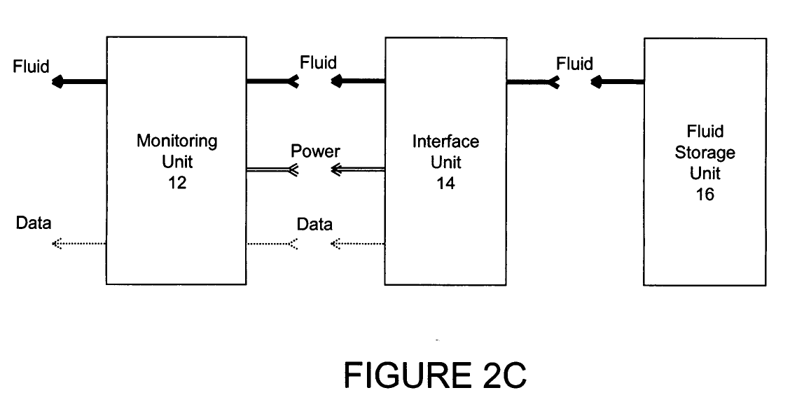

With reference to FIGS. 1A, 2A, 2B and 2C, in one exemplary embodiment, fluid delivery, monitoring and/or management system 10 includes monitoring unit 12 (according to any of the embodiments discussed herein), interface unit 14 (according to any of the embodiments discussed herein), and fluid storage unit 16 (according to any of the embodiments discussed above). The monitoring unit 12 outputs or provides the fluid to the user/operator and/or one or more external devices coupled thereto to receive the fluid. The monitoring unit may be fixed to and associated with an external device (for example, a cooking grill), fixed to a stationary platform or structure (for example, a wall of a hospital room) or a free-standing apparatus.

The monitoring unit 12, in at least one embodiment, controls, manages and/or measures one or more operating parameters of interface unit 14 and/or fluid storage unit 16. The monitoring unit 12 may also output or provide data which is representative of one or more operating parameters interface unit 14 and/or fluid storage unit 16 to the user/operator and/or external circuitry (for example, circuitry located at a local station, central station and/or fluid supplier, and/or circuitry of the user/operator (whether such user/operator is located locally or remotely)). As noted above, the operating parameters may be, for example, the amount of fluid remaining in the fluid storage unit, the amount of fluid dispensed, the rate of fluid consumption, the rate of flow of fluid, the time (or estimation thereof) remaining until all (or a predetermined amount) of the fluid is dispensed, and/or any malfunctions or faults (for example, a fluid leak, mechanical, electrical and/or electronic interface fault) of the system, or components, elements and/or subsystems thereof.

The interface unit 14, in at least one embodiment, is disposed between monitoring unit 14 and fluid storage unit 16 and includes mechanical, electrical and fluid interfaces 18a-18c, respectively, to interconnect fluid monitoring unit 12 and to interface unit 14. The interface unit 14 includes mechanical and fluid interfaces 20a and 20b, respectively, to interconnect interface unit 14 to fluid storage unit 16. In one embodiment, interface unit 14 is fixed to and associated with one or more fluid storage units 16. In another embodiment, interface unit 14 engages with and disengages from one or more fluid storage units 16 (for example, via a quick-connect type adaptor).

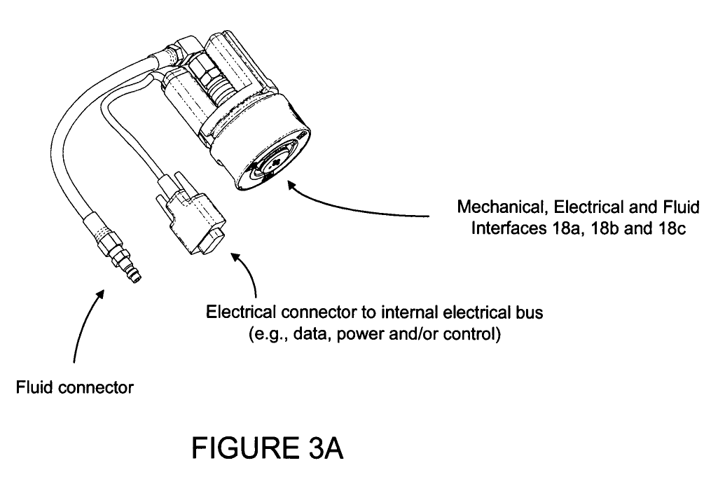

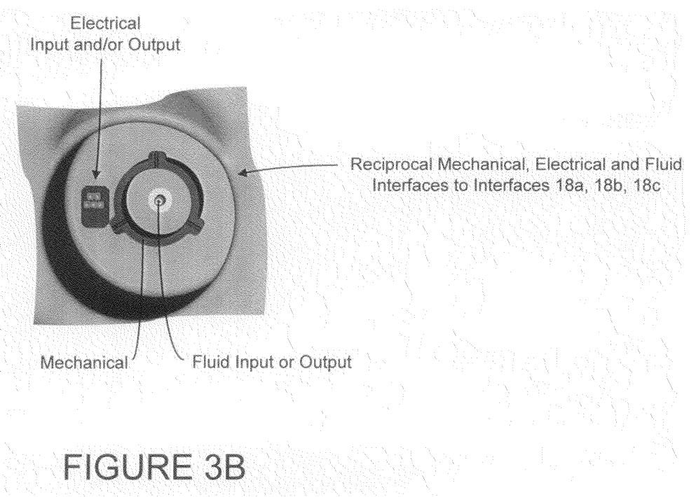

In one exemplary embodiment, interface unit 14 includes one or more mechanical interfaces 18a that facilitates “twist-on” mating with monitoring unit 12 and/or fluid storage unit 16 (in those instances where interface unit 14 is not fixed to a particular fluid storage unit 16), electrical interface 18b that allows for communication with circuitry disposed in monitoring unit 12, and fluid interface 18c that provides for fluid communication between fluid storage unit 16 and monitoring unit 12. (See, for example, FIGS. 3A and 3B). The monitoring unit 12 and/or fluid storage unit 16 include reciprocal interfaces which mate with interfaces 18 and 20, respectively. In one embodiment, interface unit 14 may include one or more (or all) of the mechanical, electrical and fluid interface mechanisms, designs, types, features, functions and operation/control techniques of any embodiment described and illustrated in non-provisional patent application Ser. No. 11/036,240, filed Jan. 14, 2005, entitled “Fuel Cell Power and Management System, and Technique for Controlling and/or Operating Same” and published as U.S. Patent Application Publication 2005/0162122 (hereinafter “Fuel Cell Power and Management System Patent Application”), which is incorporated by reference herein in its entirety.

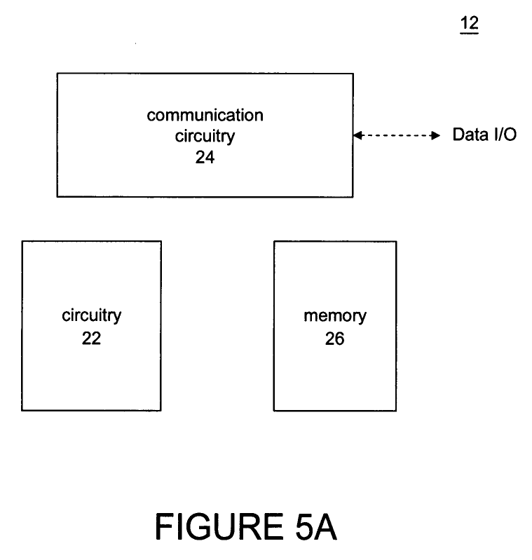

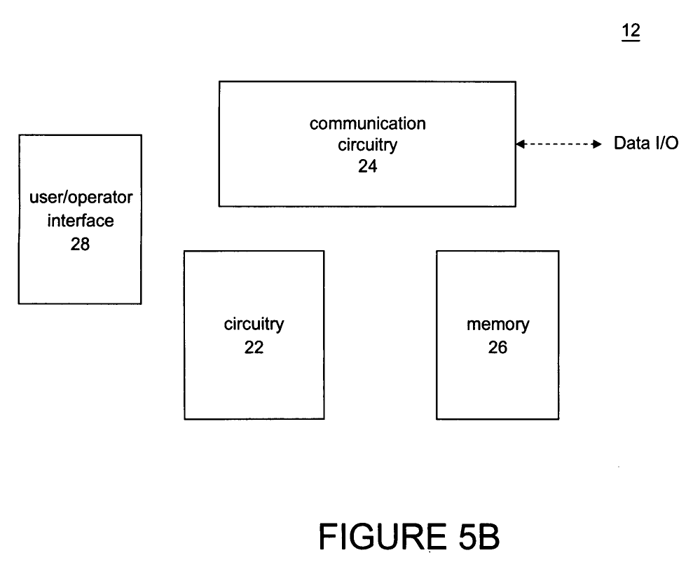

With reference to FIGS. 1A, 4A and 5A, in one embodiment, monitoring unit 12 includes circuitry 22 to calculate and/or determine data which is representative of the one or more operating parameters of system 10 and/or components thereof (for example, interface unit 14 and/or fluid storage unit 16). The circuitry 22 may include a microprocessor, microcontroller, state machine, discrete logic, and/or programmable gate array (for example, field programmable gate array). The circuitry 22 may further control, manage and/or measure the one or more operating parameters of interface unit 14 and/or fluid storage unit 16. The circuitry 22 may intermittently, continuously, periodically, on the occurrence of an event (whether an internal event or an external event) and/or at predetermined time, monitor, control, manage and/or measure the one or more operating parameters of interface unit 14 and/or fluid storage unit 16. The circuitry 22 may employ or use data provided by/from sensing and/or measuring device (for example, one or more flow meters to measure and/or determine the rate of flow of fluid, clock circuitry, temperature and/or pressure data provided by sensors disposed on/in and/or associated with the fluid storage unit). In addition thereto, or in lieu thereof, circuitry 22 may employ or use data provided by/from interface unit 14.

The monitoring unit 12 may provide the data which is representative of one or more operating parameters of interface unit 14 and/or fluid storage unit 16 to external circuitry (for example, circuitry disposed at a remote location, such as, circuitry at a central station and/or fluid supplier/provider). Notably, the monitoring unit may include wired and/or wireless communication circuitry 24 to provide the data via wired and/or wireless techniques. Indeed, monitoring unit 12 may receive or obtain software and/or firmware (whether new or upgrades) via communication circuitry 24 from local or remote location(s). For example, where a new fluid, pressure regulator, mass flow controller, sensor and/or actuator is implemented in the delivery system with new or modified characteristics, appropriate control data may be provided to monitoring unit 12 and/or interface unit 14.

As mentioned above, monitoring unit 12 may also output or provide data which is representative of the physical location of monitoring unit 12, interface unit 14 and/or fuel storage unit 16. As such, circuitry 22 and/or communication circuitry 24 may include circuits (RFID, GPS or the like) to provide for example, a local station, central station, fluid supplier, and/or user/operator (whether such user/operator is located locally or remotely), the physical location of one or more of monitoring unit 12, interface unit 14 and/or fuel storage unit 16. Such circuitry may correlate the data with mapping-type software to illustrate the physical location. In one embodiment, circuitry (whether located locally or remotely from monitoring unit 12, interface unit 14 and/or fuel storage unit 16) may determine, schedule, plan and/or calculate a route or schedule for the delivery of new fluid storage units 16 to replenish the consumed units and/or route the filling vehicle to fill the fluid storage units that are relatively fixed.

The monitoring unit 12 may include memory 26 (for example, dynamic or static memory (whether discrete or integrated with the circuitry) such as SRAM, DRAM, ROM, PROM, EPROM and/or EEPROM) to receive and store data or information which is representative of the one or more operating parameters (for example, current or historical type information). The memory 26 may receive and store data which uniquely or specifically identifies (from the perspective of one or more other storage units) interface unit 14 and/or fluid storage unit 16. Notably, all forms or types of memory, whether now known or later developed, are intended to fall within the scope of the present inventions. Indeed, memory 26 may be integrated into circuitry 22 and/or circuitry 24.

As noted above, monitoring unit 12 may include a user/operator interface 28, for example, a display (for example, an LCD or LED display) to visually display information which is representative of one or more of the operating parameters of interface unit 14 and/or fluid storage unit 16. In addition thereto, or in lieu thereof, user/operator interface 28 may include an audible indicator and/or an input mechanism (for example, one or more button switches or keypad) to receive user/operator inputs, data, commands and/or instructions. In addition, monitoring unit 12 may include a power source (for example, local power source such as a battery or fuel cell) or receive or generate power (e.g., 24V, 110V or 220V) for the circuitry/devices/components of monitoring unit 12 and/or interface unit 14.

It should be noted that circuitry 22, circuitry 24, and/or memory 26 may be comprised of discrete component(s) or may be integrated. Indeed, such circuitry and memory may reside on or in an integrated circuit that performs other operations, for example, processing circuitry (such as a microcontroller or microprocessor).

As mentioned above, in another embodiment, monitoring unit 12 may also detect/determine the configuration of system 10. In this embodiment, monitoring unit 12 may detect/determine certain “fixed” operating parameters of the fluid (for example, delivery/output pressure) in the fluid storage unit 16 and assess and/or evaluates whether to receive the fluid from storage unit 16 (or interface unit 14) and/or whether to output or provide the fluid to, for example, the user/operator. Moreover, based on the intended use of the fluid as well as the configuration of system 10 (as detected/determined), control and/or manage one or more components of system 10 (such as a pressure regulator, mass flow controller, flow restriction values or the like) such that the parameters (for example, pressure, flow rate and/or fluid type/mixture) of the fluid output from storage unit 16 (or interface unit 14) and/or output from monitoring unit 12 is suitable or acceptable based on, for example, the intended use of the fluid.

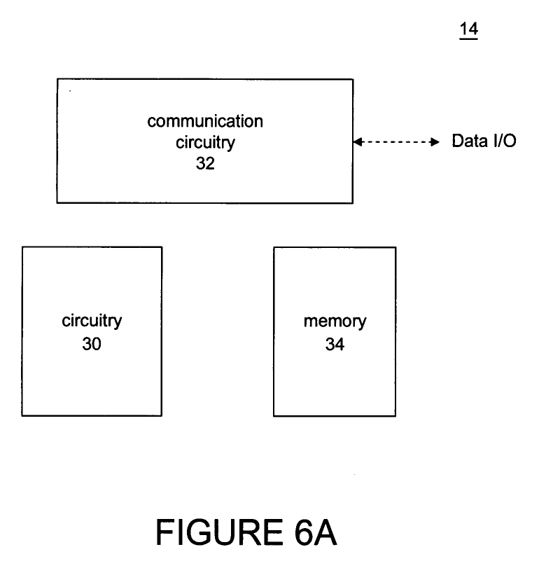

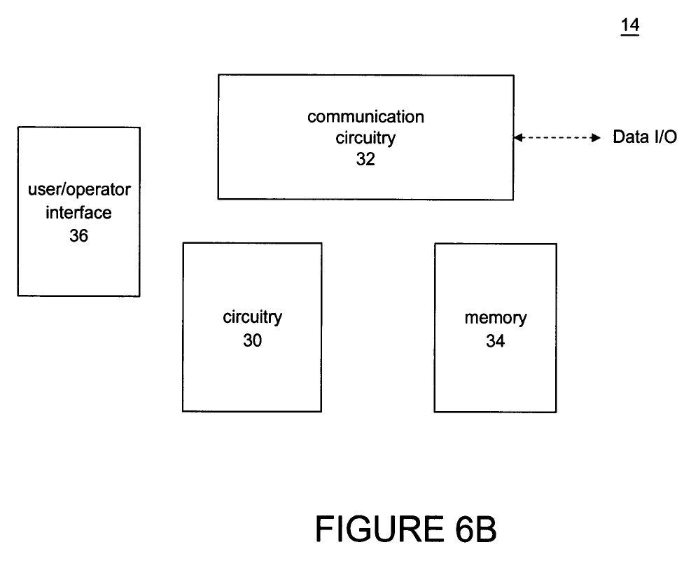

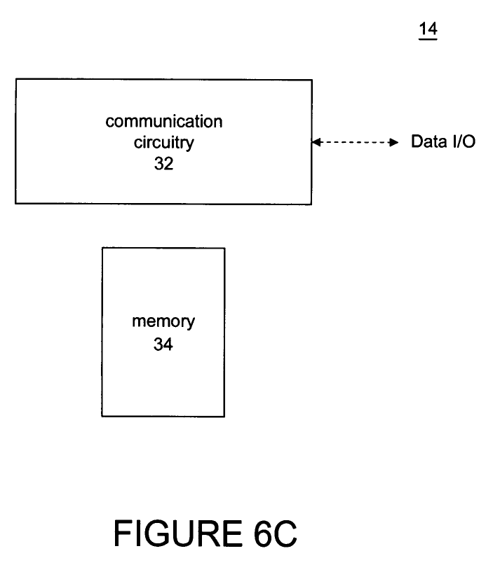

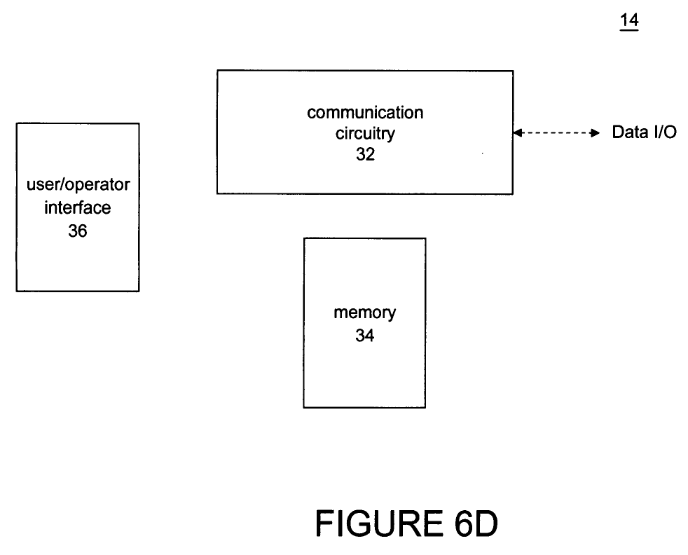

With reference to FIG. 6A, in one embodiment, interface unit 14 includes circuitry 30 (for example, a microprocessor, microcontroller, state machine, discrete logic, and/or programmable gate array (for example, field programmable gate array)) to calculate and/or determine data which is representative of the one or more operating parameters of system 10 and/or fluid storage unit 16. In this embodiment, interface unit 14 includes circuitry 30 to calculate and/or determine data which is representative of the one or more operating parameters. As described above, monitoring unit 12, interface unit 14, in one embodiment, includes and/or employ any sensing and/or measuring technique and/or device (for example, one or more flow meters to measure and/or determine the rate of flow of fluid, clock circuitry, temperature and/or pressure data provided by sensors disposed on/in the fluid storage unit). Thus, in addition to monitoring unit 12 calculating and/or determining data or information which is representative of one or more operating parameters of interface unit 14 and/or fluid storage unit 16 (as discussed above), or in lieu thereof, the data or information which is representative of one or more operating parameters may be calculated and/or determined by circuitry 30 in interface unit 14.

The interface unit 14 may include communication circuitry 32 which communicates and/or interacts with circuitry in monitoring unit 12 and/or circuitry of an external device (other than the monitoring unit). In one embodiment, interface unit 14 may provide data which is representative of one or more operating parameters of fluid storage unit 16 (for example, data which is stored in a memory device in interface unit 14) to monitoring unit 12 and/or external circuitry located, for example, at a remote location, the system facilitates remote monitoring, controlling, tracking and/or managing thereof. The data may include current or historical data which is representative of one or more operating parameters (for example, “real-time” data or temporally correlated data of one or more operating parameters).

As discussed above, interface unit 14 may directly receive inputs, data, commands and/or instructions from an external device (other than the monitoring unit). Such inputs, data, commands and/or instructions may be received by communication circuitry 32 via wired and/or wireless interconnection with such external device. Indeed, interface unit 14 may receive or obtain software and/or firmware (whether new or upgrades) via communication circuitry 32 from local or remote location(s). For example, where a new fluid, pressure regulator, mass flow controller, sensor and/or actuator is implemented in the delivery system with new or modified characteristics, appropriate control data may be provided to monitoring unit 12 and/or interface unit 14.

Notably, interface unit 14 may also output or provide data which is representative of the physical location of monitoring unit 12, interface unit 14 and/or fuel storage unit 16. The circuitry 30 and/or communication circuitry 32 may include circuits (RFID, GPS or the like) to provide for example, a local station, central station, fluid supplier, and/or user/operator (whether such user/operator is located locally or remotely), the physical location of one or more of monitoring unit 12, interface unit 14 and/or fuel storage unit 16. Such circuitry may correlate the data with mapping-type software to illustrate the physical location. In one embodiment, circuitry (whether located locally or remotely from monitoring unit 12, interface unit 14 and/or fuel storage unit 16) may determine, schedule, plan and/or calculate a route or schedule for the delivery of new fluid storage units 16 to replenish the consumed units and/or route the filling vehicle to fill the fluid storage units that are relatively fixed.

With continued reference to FIG. 6A, interface unit 14 may include memory 34 (for example, dynamic or static memory (whether discrete or integrated with the circuitry) such as SRAM, DRAM, ROM, PROM, EPROM and/or EEPROM) to receive and store data or information which is representative of the one or more operating parameters (for example, current or historical type information). The data or information which is representative of one or more operating parameters may include a current status and/or historical data (for example, temporally correlated data of one or more operating parameters). The memory 34 may store data which uniquely or specifically identifies (from the perspective of one or more other storage units) interface unit 14 and/or fluid storage unit 16. Notably, all forms or types of memory, whether now known or later developed, are intended to fall within the scope of the present inventions. Indeed, memory 32 may be integrated into circuitry 30 and/or circuitry 32.

With reference to FIG. 6B, interface unit 14 may include a user/operator interface 36, for example, a display (for example, an LCD or LED display) to visually display information which is representative of one or more of the operating parameters of the fluid storage unit and/or the interface. In addition thereto, or in lieu thereof, user/operator interface 36 may include an audible indicator and/or an input mechanism (for example, one or more button switches or keypad) to receive user/operator inputs, data, commands and/or instructions. The interface unit may also include a power source (for example, local power source such as a battery or fuel cell) or receive or generate power (e.g., 24V, 110V or 220V) for the circuitry/devices of interface unit 14 and/or monitoring unit 12.

Notably, in certain embodiments, interface unit 14 does not include circuitry 30 to calculate and/or determine data which is representative of the one or more operating parameters of system 10 and/or fluid storage unit 16. In this embodiment, system 10 employs monitoring unit 12 to calculate and/or determine that data which is representative of the one or more operating parameters. (See, for example, FIGS. 6C and 6D).

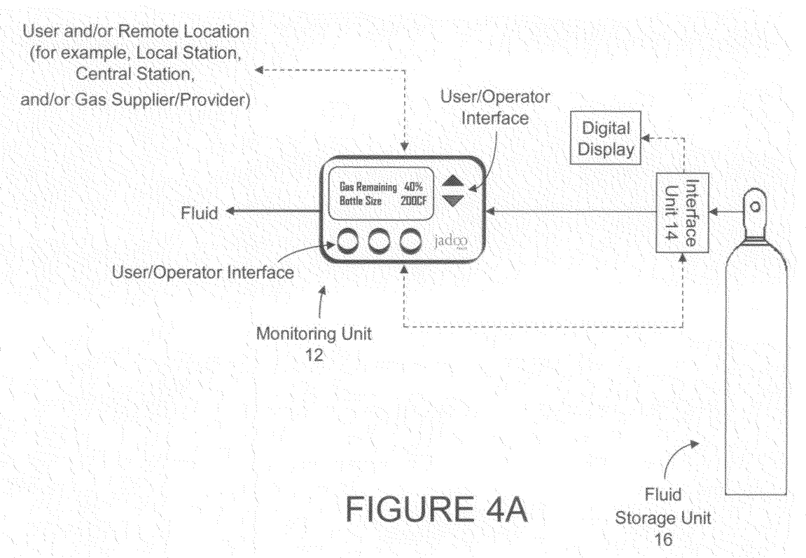

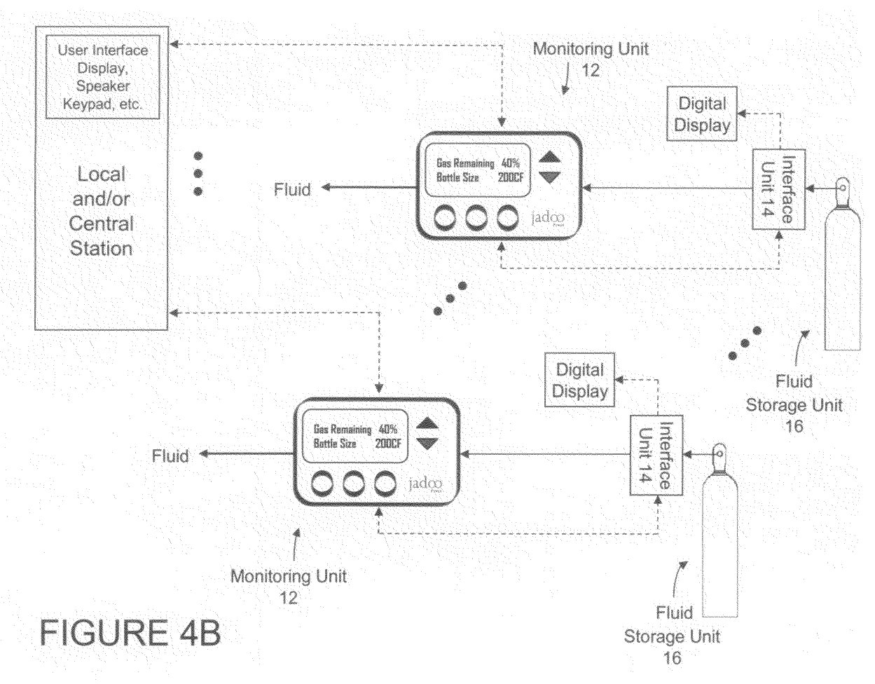

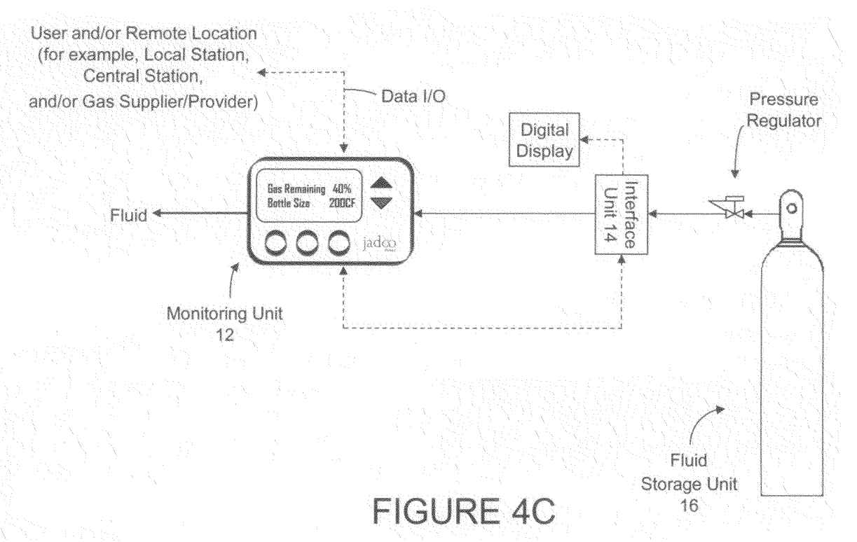

With reference to FIGS. 1A and 4A, fluid storage unit 16 stores one or more fluids (for example, oxygen, nitrogen, carbon dioxide, hydrogen, and/or propane) in, for example, solid, liquid, gas and/or gas vapor forms. Such fluid(s) may be pressurized or non-pressurized. The fluid storage unit 16 may be mobile (for example, portable and/or transportable between a plurality of locations), such as a K-bottle or immobile (for example, permanently or semi-permanently fixed in a predetermined location) such as a buried tank.

In operation, in one embodiment, interface unit 14 may initially provide data which is representative of one or more operating parameters to monitoring unit 12. For example, interface unit 14 may provide data which is representative of the amount of fluid remaining in storage unit 16, the amount of fluid dispensed, and/or any malfunctions or faults (for example, a fluid leak, mechanical, electrical and/or electronic interface fault) of interface unit 14 and/or fluid storage unit 16. In addition, interface unit 14 may provide “unique” data/information (as discussed above) to monitoring unit 12. In this regard, interface unit 14 may provide specific or unique information associated with, for example, fluid storage unit 16 (for example, an associated serial number, date of manufacture and/or assembly, data pertaining to the supplier of one or more components of interface unit 14 and/or storage unit 16, fluid storage capacity, revision or series of electronics/software, model number of interface unit 14, date of certification and/or recertification, and/or type of fluid stored in fluid storage unit 16. As noted above, monitoring unit 12 may receive such data via wired and/or wireless (for example, RF or optical) techniques.

In one exemplary operation, the state of fill of fluid storage unit 16 may be monitored and/or controlled via circuitry 22 in monitoring unit 12 and/or circuitry 30 that resides in interface unit 14. The monitoring unit 12 may determine the state of fill, “decrement” or adjust the state of fill (to reflect any changes thereto) and provide that information to (1) external circuitry (for example, locally (to a computer or PDA coupled to the unit) or remotely (for example, to a computer or the like located at a central station)) and/or (2) circuitry in the interface unit. The interface unit 14 may store the data or information in memory 34 contained therein.

Notably, monitoring unit 12 may include and/or employ any sensing and/or measuring technique and/or device (for example, one or more flow meters to measure and/or determine the rate of flow of fluid, clock circuitry, temperature and/or pressure data provided by sensors disposed on/in the fluid storage unit) whether now known or later developed. The circuitry 22 (for example, a microcontroller or microprocessor) calculates and/or determines the data which is representative of the one or more operating parameters using data generated/provided by such sensing and/or measuring technique and/or device.

In addition to providing a “real-time” state of fill of fluid storage unit 16, or in lieu thereof, monitoring unit 12 may notify (for example, via an audible or visual indicator) the remote circuitry (for example, in the context of a hospital, the nurse or technician at a local station and a central location such as a central administrator or fluid supplier/provider) upon dispensing all or nearly dispensing all of the fluid in fluid storage unit 16. In response, the nurse or technician may change/replace fluid storage unit 16. In addition, as noted above, a central location may monitor, track, control and/or manage such data to provide a representation of historical and/or current inventory, to address organization needs (for example, re-supply), and/or to more effectively manage, monitor and/or track inventory of fluid storage units 16. In this way, resources (for example, manpower of the fluid supplier/provider as well as size/cost of inventory) may be more efficiently and cost effectively managed by more effectively managing, monitoring and/or tracking inventory of the fluid storage unit at customer/user sites using features of the system and methods of the present inventions.

Indeed, the remote station may provide/display data which is representative of one or more operating parameters of a plurality of fluid storage units (which may be, for example, located in one or more rooms located on the same or different floors). (See, for example, FIG. 4B).

Notably, the fluid storage unit may contain/store one or more pressurized or non-pressurized fluids. Such fluid(s) may be stored in, for example, solid, liquid, gas and/or gas vapor forms. Moreover, such fluid(s) may be oxygen, nitrogen, carbon dioxide, hydrogen, and/or propane. Where the fluid storage unit contains/stores a pressurized fluid it may be advantageous to employ a pressure regulator to establish and/or maintain a suitable, desired and/or predetermined delivery pressure of the fluid (in relation to the interface unit). (See, for example, FIG. 4C). Moreover, as noted above, the system may include a mass flow controller to control, provide and/or determine the rate of deliver of the fluid from the fluid storage unit. The pressure regulator and/or the mass flow controller may be electrically controllable which allows the monitoring unit and/or the interface unit to control the flow on a real time basis and/or in response to the operator/user request or instruction.

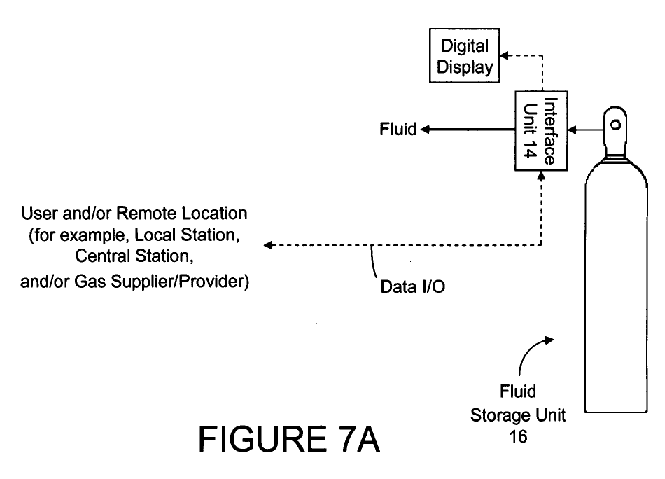

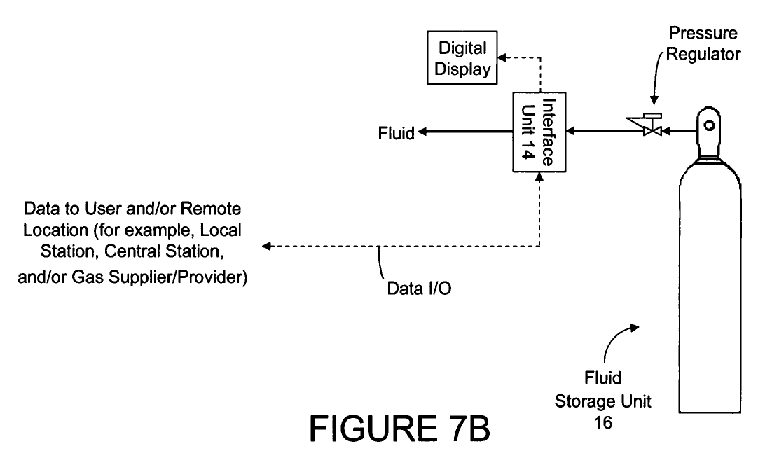

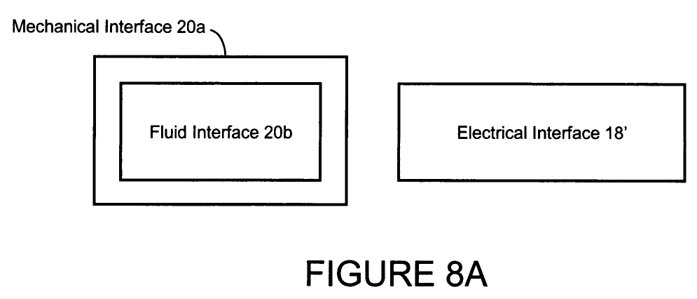

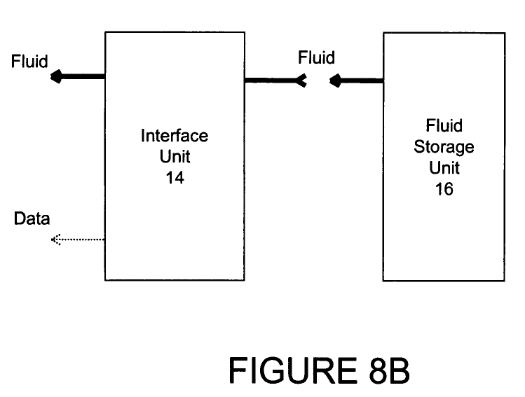

With reference to FIGS. 7A, 8A and 8B, in one embodiment, system 10 includes interface unit 14 and fluid storage unit 16. In this embodiment, system 10 does not include a separate monitoring unit 12. As such, interface unit 14 includes circuitry 30 to perform the operations/functions described above with respect to circuitry 22 of monitoring unit 12. (See, for example, FIGS. 6A and 6B). Indeed, interface unit 14 of the embodiment of this embodiment may include any of the circuitry, mechanisms, designs, types, features, functions and operation/control techniques of any embodiment described and illustrated in the context of monitoring unit 12. For the sake of brevity, those discussions will not be repeated.

As such, in this embodiment, circuitry 30 in interface unit 14 monitors, controls, manages and/or measures one or more operating parameters of fluid storage unit 16, in an intermittent, continuous, periodic and/or a predetermined manner, using the data provided by/from any sensing and/or measuring technique and/or device. In one embodiment, circuitry 30 may control, manage and/or measure the one or more operating parameters of fluid storage unit 16 in response to or based on the occurrence of an event (whether an internal event or an external event). The interface unit 14 may provide the data which is representative of one or more operating parameters of fluid storage unit 16 to a user/operator interface 36 (for example, a visual and/or audible indicator on or associated with interface unit 14) and/or to external circuitry (for example, circuitry located at a remote location (for example, a local and/or central station) and/or fluid supplier/provider, or circuitry of the user/operator). Notably, interface unit 14 may provide the data to external circuitry via communication circuitry 32 (for example, via wired and/or wireless techniques).

Accordingly, in one exemplary operation of this embodiment, as noted above, the state of fill of the fluid storage unit may be monitored and/or controlled via circuitry 30 of interface unit 14. The interface unit 14 may determine the state of fill, “decrement” or adjust the state of fill (to reflect any changes thereto) and provide that information to (1) external circuitry (for example, locally (to a computer or PDA coupled to the unit) or remotely (to a computer or the like located at a central station)) and/or (2) circuitry (for example, memory 34 and/or user/operator interface 36) of interface unit 14. As mentioned above, interface unit 14 may store the information in memory 34.

The fluid storage unit of this embodiment may contain/store a pressurized or non-pressurized fluid (for example, in the form of a liquid, gas and/or gas vapor). Where the fluid storage unit contains/stores a pressurized fluid it may be advantageous to employ a pressure regulator to establish and/or maintain a suitable, desired and/or predetermined delivery pressure of the fluid (in relation to the interface unit). (See, for example, FIG. 7B).

The present inventions may be implemented in a plurality of configurations. For example, with reference to FIGS. 1A, 2A, 2B, 9A and 9B, in one embodiment, fluid delivery and monitoring system 10 includes monitoring unit 12 to monitor, control, manage and/or measure the delivery and/or flow of fluid from a plurality of fluid storage units 16 (for example, two or more K-bottle size tanks). In this embodiment, system 10 includes monitoring unit 12 which is connected to a plurality of interface units 14, each of which is associated with a fluid storage unit 16. Notably, monitoring system 10 may output fluid individually and/or sequentially from one of the interface units-fluid storage units or simultaneously output fluid from a subset or all of interface units-fluid storage units. As such, monitoring unit 12 monitors, controls, manages and/or measures the delivery and/or flow of fluid from the plurality of fluid storage units 16 accordingly.

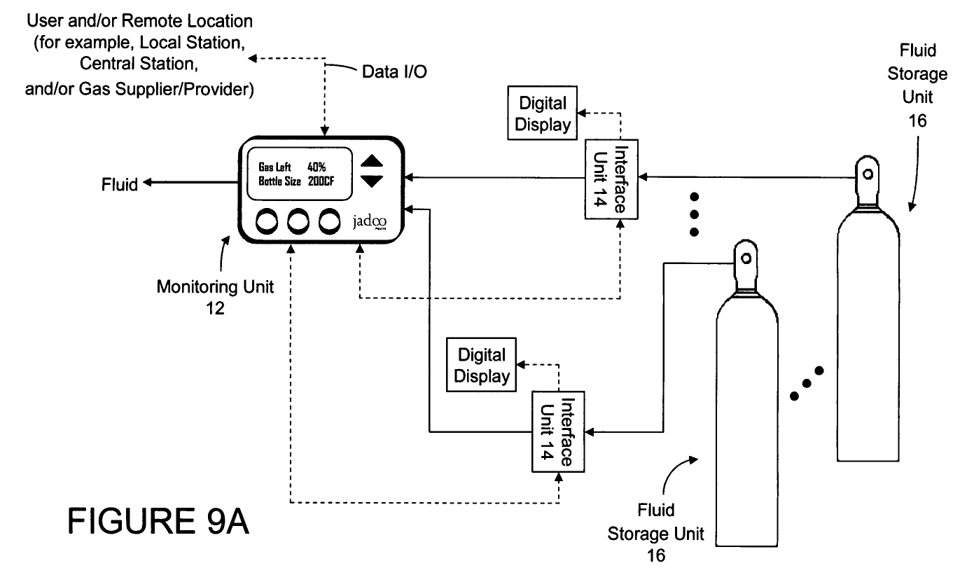

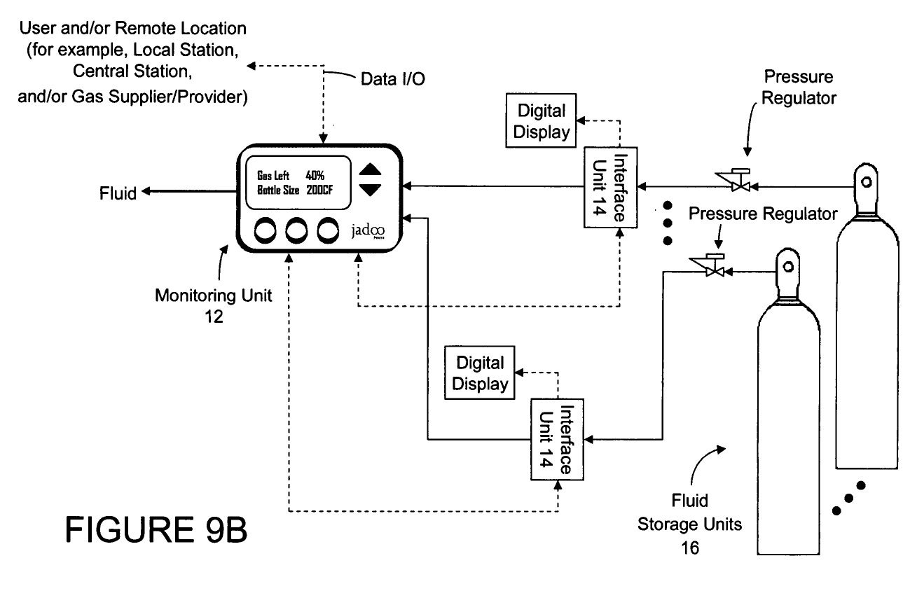

With reference to FIGS. 1A, 2A, 2B, 9A and 9B, monitoring unit 12 may provide data which is representative of one or more operating parameters of fluid storage units 16 (for example, amount of fluid remaining in each storage unit 16) to external circuitry (for example, circuitry located at a central station and/or fluid supplier, or circuitry of the user/operator). In addition thereto, or in lieu thereof, monitoring unit 12 may provide (and store) the data which is representative of one or more operating parameters of each fluid storage unit 16 to the corresponding or associated interface unit 14. The monitoring unit 12 of this embodiment may employ or include any or all of the features, circuitry and mechanisms discussed above. Indeed, monitoring unit 12 may be implemented according to any of the embodiments discussed above. As such, the monitoring unit, interface unit and fluid storage unit of the embodiments of FIGS. 9A and 9B may include any of the circuitry, mechanisms, designs, types, features, functions and operation/control techniques of any embodiment described and illustrated herein. For the sake of brevity, those discussions will not be repeated.

Notably, in this embodiment, circuitry 22 and/or circuitry 30 may monitor, control, manage and/or measure the output of fluid from monitoring unit 12, the use of fluid from the plurality of interface units 14 and/or fluid storage units 16, and determine the state of fill of fluid storage units 16 (and/or changes therein). The circuitry 22 and/or circuitry 30 may monitor, control, manage and/or measure the use of fluid from the plurality of fluid storage units 16 as well as determine the state of fill of fluid storage units 16 (and/or changes therein) on an individual basis and/or a collective basis. Thus, for each fluid storage unit 16 individually as well as all fluid storage units 16 of system 10, monitoring unit 12 may monitor, control, manage and/or measure, the amount of fluid dispensed, the rate of fluid consumption, the rate of flow of fluid, the time (or estimation thereof) remaining until all (or a predetermined amount) of the fluid is dispensed, and/or any malfunctions or faults (for example, a fluid leak, mechanical, electrical and/or electronic interface fault) of the system, or components, elements and/or subsystems thereof.

Notably, in one embodiment, circuitry 22 of monitoring unit 12 and/or circuitry 30 of interface unit 14 may employ the same or similar techniques for determining the state of fill of fluid storage units 16 (and/or changes therein) on an individual basis and/or a collective basis as described and illustrated in non-provisional patent application Ser. No. 11/789,378, filed Apr. 24, 2007, entitled “Fuel Cell Power System having Dock-Type Device, and Technique for Controlling and/or Operating Same” and published as U.S. Patent Application Publication 2007/0248851, which is incorporated by reference herein in its entirety.

The monitoring unit 12 may also include mechanisms, devices and/or circuitry (for example, distributing valves, mass flow controller, flow meters, pressure regulators and control circuitry) to “mix” (for example, in controlled amounts) two or more of the fluids in fluid storage units 16 to provide a “compound” fluid based on the fluids in one or more of fluid storage units 16. In this embodiment, monitoring unit 12 may provide a compound fluid (based on the fluids in two or more of the fluid storage units) and monitor, control, manage and/or measure, individually for each fluid storage unit, the monitor the amount of fluid dispensed, the rate of fluid consumption, the rate of flow of fluid, and/or the time (or estimation thereof) remaining until all (or a predetermined amount) of the fluid is dispensed.

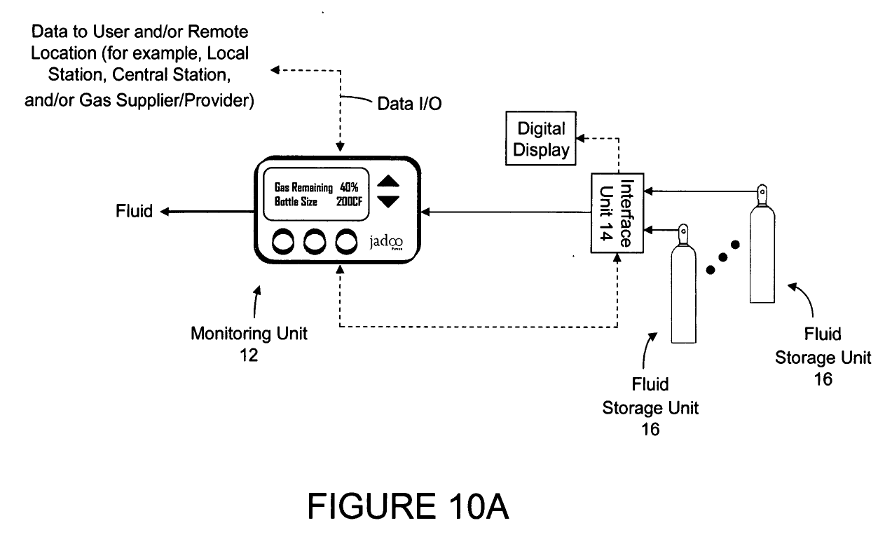

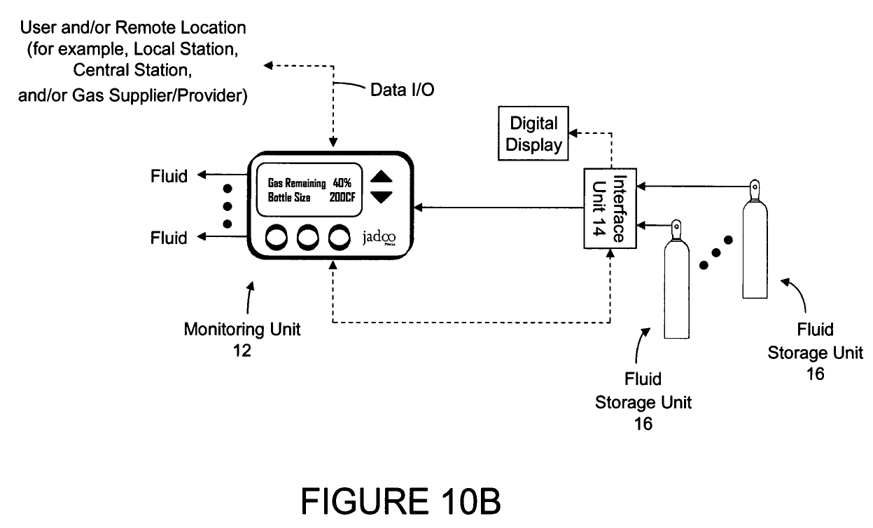

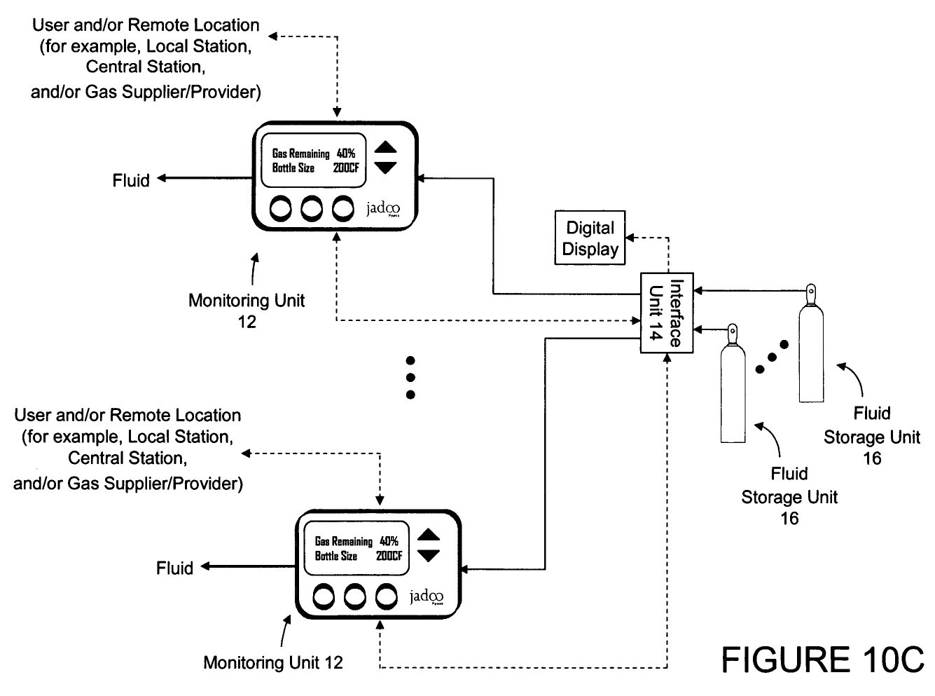

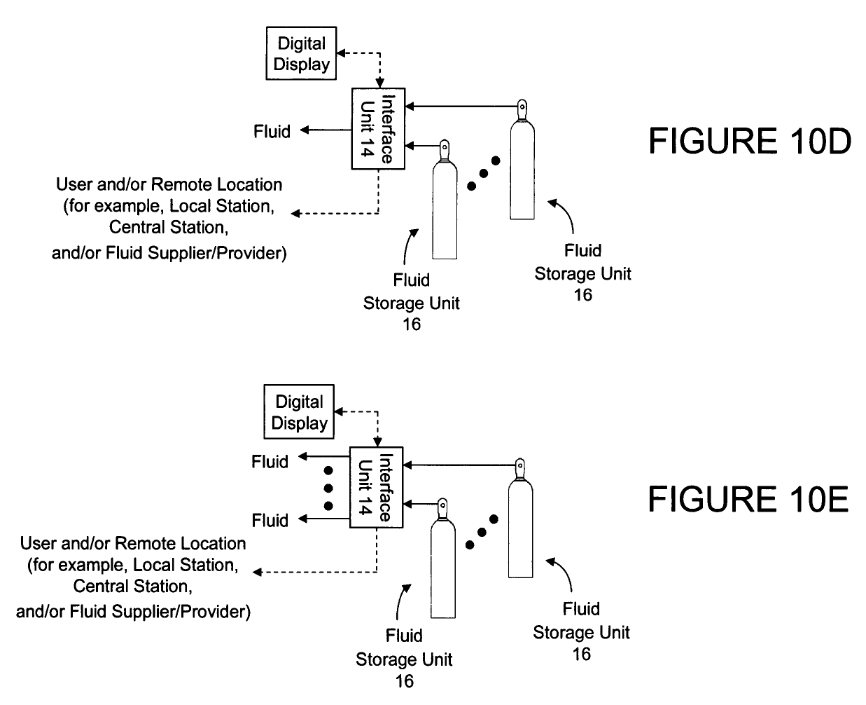

With reference to FIGS. 10A-10E, in certain configurations, interface unit 14 may couple to a plurality of fluid storage units (which may contain the same type or different types of fluids). In this regard, interface unit 14 may include a plurality of fluid interfaces to mate with each of fluid storage units 16. The interface unit of FIGS. 10A-10E may employ or include any or all of the features, circuitry and mechanisms discussed above. For example, interface unit 14 may include one or more memory devices (for example, SRAM, DRAM, ROM, PROM, EPROM and/or EEPROM) to store or maintain data or information which is representative of the one or more operating parameters of the fluid(s) stored in one, some or all of fluid storage units 16. As indicated above, the data or information which is representative of one or more operating parameters may include a current status and/or historical data (for example, temporally correlated data of one or more operating parameters).

The data or information which is representative of one or more operating parameters may be calculated and/or determined in monitoring unit 12 (as discussed above) and provided to the interface unit. (See, for example, FIGS. 10A-10C). In addition thereto, or in lieu thereof, the data or information which is representative of one or more operating parameters may be calculated and/or determined in the interface unit which may include circuitry (for example, a microcontroller or microprocessor) to calculate and/or determine the data which is representative of the one or more operating parameters. (See, for example, FIGS. 10D and 10E). As with monitoring unit 12, interface unit 14 may include and/or employ any sensing and/or measuring technique and/or device (for example, one or more flow meters to measure and/or determine the rate of flow of fluid, clock circuitry, temperature and/or pressure data provided by sensors disposed on/in the fluid storage unit).

Notably, interface unit may be implemented according to any of the embodiments discussed above. The interface unit as well as the monitoring unit and fluid storage unit of the embodiments of FIGS. 10A-10E may include any of the circuitry, mechanisms, designs, types, features, functions and operation/control techniques of any embodiment described and illustrated herein. For the sake of brevity, those discussions will not be repeated.

In addition, interface unit 14 may employ and/or include any of the circuitry, mechanisms, designs, types, features, functions and operation/control techniques of any embodiment described and illustrated herein with respect to monitoring unit 12. For example, with reference to FIG. 10A-10E, interface unit 14 may monitor, manage and/or control one or more operating parameters of fluid storage units 16 (for example, amount of fluid remaining in each storage unit) to external circuitry (for example, circuitry located at a central station and/or fluid supplier, or circuitry of the user/operator). In addition thereto, or in lieu thereof, interface unit 14 may store and/or maintain data which is representative of one or more operating parameters of each fluid storage unit 16. The interface unit 14 of this embodiment may employ or include any or all of the features, circuitry and mechanisms discussed herein. For the sake of brevity, those discussions will not be repeated.

Notably, as indicated above, interface unit 14 may also monitor, control, manage and/or measure, individually for each fluid storage unit, and/or collectively, the amount of fluid dispensed, the rate of fluid consumption, the rate of flow of fluid, the time (or estimation thereof) remaining until all (or a predetermined amount) of the fluid is dispensed, and/or any malfunctions or faults (for example, a fluid leak, mechanical, electrical and/or electronic interface fault) of the system, or components, elements and/or subsystems thereof. The interface unit 14 may also “mix” (in, for example, controlled amounts) two or more of the fluids in fluid storage units 16 to provide a compound fluid based on the fluids in one or more of fluid storage units 16. In this embodiment, interface unit 14 may provide a compound fluid (based on the fluids in two or more of the fluid storage units) and monitor, control, manage and/or measure, individually for each fluid storage unit, the monitor the amount of fluid dispensed, the rate of fluid consumption, the rate of flow of fluid, and/or the time (or estimation thereof) remaining until all (or a predetermined amount) of the fluid is dispensed. For example, the inventions described herein may be employed in the food packaging industry, wherein a modified atmosphere packaging or controlled atmosphere packaging improves shelf life and in many cases the appearance of the foods without the need for chemicals. In this example, the primary gases used are carbon dioxide, oxygen and nitrogen. Mixing allows for controlled change in mixture composition to accommodate different requirements, constraints and/or considerations.

Thus, for each fluid storage unit 16 as well as fluid storage units 16 collectively, monitoring unit 12 and/or interface unit 14 may monitor, control, manage and/or measure, the amount of fluid dispensed, the rate of fluid consumption, the rate of flow of fluid, the time (or estimation thereof) remaining until all (or a predetermined amount) of the fluid is dispensed, and/or any malfunctions or faults (for example, a fluid leak, mechanical, electrical and/or electronic interface fault) of the system, or components, elements and/or subsystems thereof.

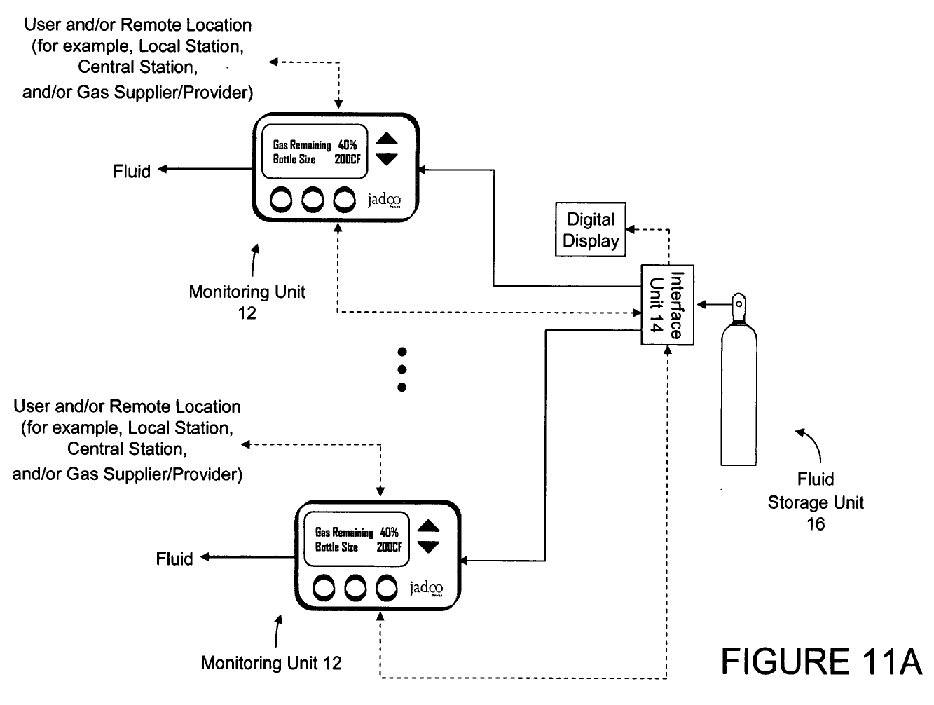

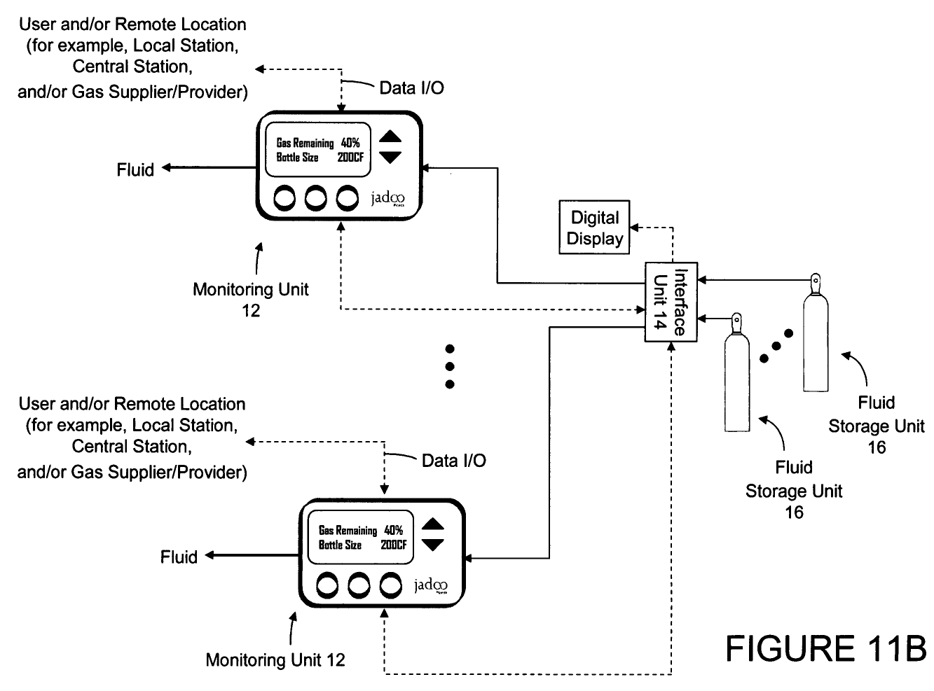

With reference to FIGS. 11A and 11B, in another configuration of the present inventions, interface unit 14 may couple to a plurality of monitoring units 12. In this regard, interface unit 14 may include a plurality of appropriate interfaces to mate with each of monitoring units 12. The interface unit 14 and monitoring units 12 of FIGS. 11A and 11B may employ or include any or all of the features, circuitry and mechanisms discussed herein. Indeed, interface unit 14 of FIGS. 11A and 11B may be implemented in any of the embodiments described and illustrated herein (for example, the embodiments of FIGS. 9A, 9B and 10A-10E). For the sake of brevity, those discussions will not be repeated.

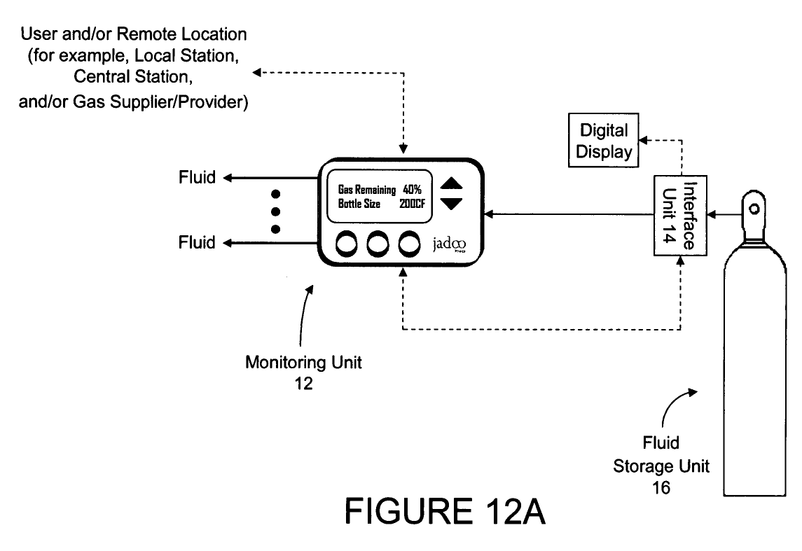

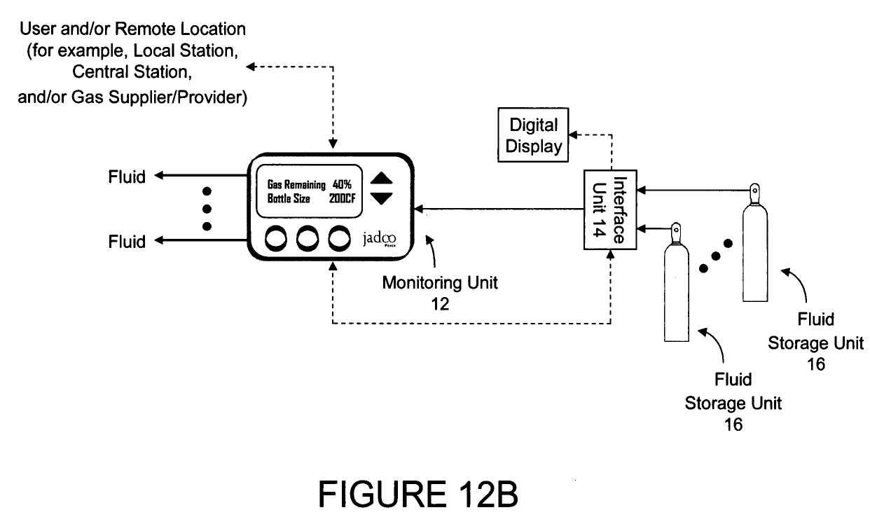

Moreover, with reference to FIGS. 12A and 12B, monitoring unit 12 may include a plurality of output fluid interfaces. The monitoring unit 12 may provide the same fluid to a plurality of users (FIG. 12A) or provide a plurality of different fluids to a plurality of users (FIG. 12B) or provide one or more fluid compounds (that is, two or more fluids in fluid storage units 16 that are “mixed” (in, for example, controlled amounts) to provide a compound fluid based on the fluids in two or more of fluid storage units 16). The monitoring unit of FIGS. 12A and 12B may employ or include any or all of the features, circuitry and mechanisms discussed above. For the sake of brevity, those discussions will not be repeated. Indeed, monitoring unit 12 of FIGS. 12A and 12B may be implemented in or using any of the embodiments described and illustrated herein.

For example, monitoring unit 12 may provide data which is representative of one or more operating parameters of fluid storage units 16 (for example, amount of fluid remaining in each storage unit 16) to external circuitry (for example, circuitry located at a central station and/or fluid supplier, or circuitry of the user/operator). In addition thereto, or in lieu thereof, monitoring unit 12 may provide (and store) the data which is representative of one or more operating parameters of each fluid storage unit 16 to interface unit 14.

Notably, in this embodiment, circuitry 22 may monitor, control, manage and/or measure the output of fluid from monitoring unit 12, the use of fluid from the plurality of interface units 14 and/or fluid storage units 16, and determine the state of fill of fluid storage units 16 (and/or changes therein). The circuitry 22 may monitor, control, manage and/or measure the use of fluid from the plurality of fluid storage units 16 as well as determine the state of fill of fluid storage unit(s) 16 (and/or changes therein) on an individual basis and/or a collective basis. Thus, with respect to the embodiment of FIG. 12B, for each fluid storage unit 16 individually as well as all fluid storage units 16 of system 10, monitoring unit 12 may monitor, control, manage and/or measure, the amount of fluid dispensed, the rate of fluid consumption, the rate of flow of fluid, the time (or estimation thereof) remaining until all (or a predetermined amount) of the fluid is dispensed, and/or any malfunctions or faults (for example, a fluid leak, mechanical, electrical and/or electronic interface fault) of the system, or components, elements and/or subsystems thereof.

The interface unit 14 may also include mechanisms, devices and/or circuitry (for example, one or more distributing valves, mass flow controllers, flow meters, pressure regulators and control circuitry) to “mix” (for example, in controlled amounts) two or more of the fluids in fluid storage units 16 to provide a “compound” fluid based on the fluids in one or more of fluid storage units 16. In this embodiment, interface unit 14 may provide a compound fluid (based on the fluids in two or more of fluid storage units 16) and monitor, control, manage and/or measure, individually for each fluid storage unit, the monitor the amount of fluid dispensed, the rate of fluid consumption, the rate of flow of fluid, and/or the time (or estimation thereof) remaining until all (or a predetermined amount) of the fluid is dispensed.

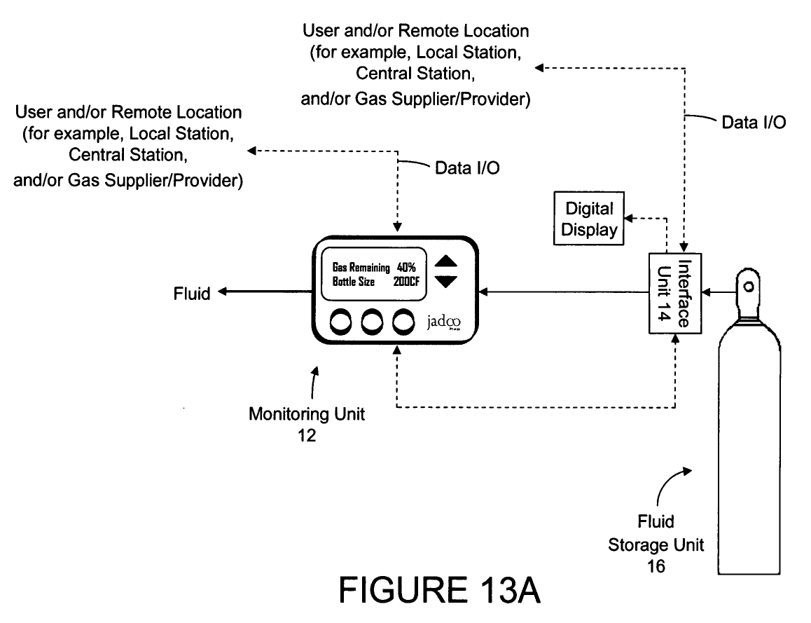

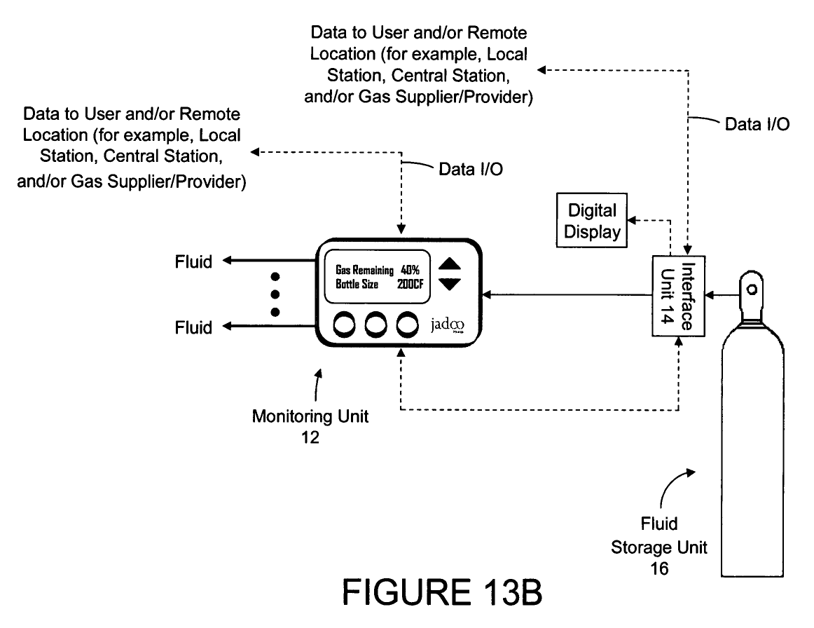

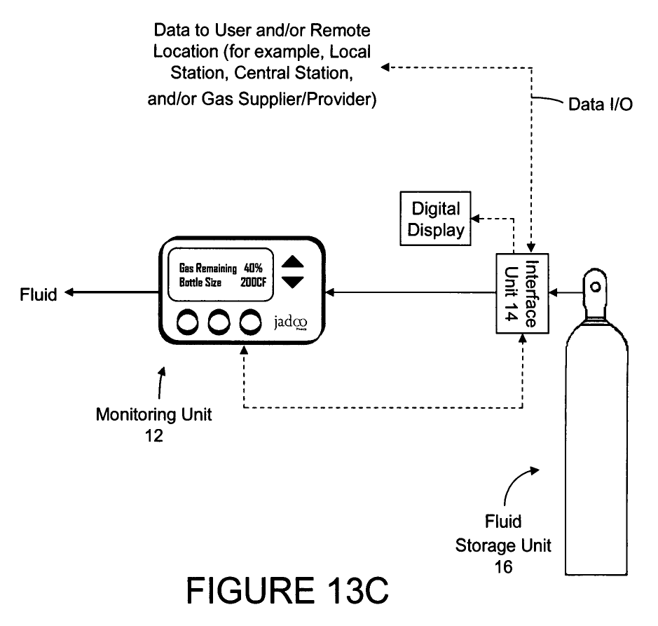

Further, as noted above, interface unit 14 may include communication circuitry 32 which facilitates direct communication with circuitry of an external device. (See, for example, FIGS. 13A-13C). In one embodiment, interface unit 14 may provide data which is representative of one or more operating parameters of fluid storage unit 16 (for example, data which is stored in memory device 34 of interface unit 14—see, for example, FIGS. 6A and/or 6B) to external circuitry located, for example, at a remote location, the system facilitates remote monitoring, controlling, tracking and/or managing thereof. The interface unit 14 may also receive inputs, data, commands and/or instructions from an external device. The interface unit 14 may employ any communication technique/circuitry (for example, wired and/or wireless (for example, RF or optical)).

Notably, interface unit 14 of FIGS. 13A-13C may employ or include any or all of the features, circuitry and mechanisms discussed herein. For the sake of brevity, those discussions will not be repeated. Indeed, interface unit 14 and/or monitoring unit 12 of FIGS. 13A-13C may be implemented in any of the embodiments described and illustrated herein. Again, for the sake of brevity, those discussions will not be repeated.

In those embodiments where a plurality of fluids are provided to and/or output by monitoring unit(s) 12 and/or interface unit(s) 14, a fluid manifold unit may be employed to control, monitor, and/or manage fluid flow. For example, a fluid manifold unit may be employed in conjunction with FIGS. 9A-13C. In one embodiment, monitoring unit(s) 12 and/or interface unit(s) 14 may include fluid manifold unit 38 to provide, facilitate and/or enable fluid communication between a plurality of fluid storage units 16 (see, for example, FIGS. 9A, 9B, 10A-10E, 11B and 12B) and/or a plurality of interface units 14 (see, for example, FIGS. 9A and 9B). In this way, a plurality of interface units 14 and/or a plurality of plurality of fluid storage units 16 may be connected/disconnected thereby facilitating adjustment of the available fluids. The monitoring unit(s) 12 and/or interface unit(s) 14 may employ any type of fluid manifold now known or later developed; all such manifolds are intended to fall within the scope of the present invention.

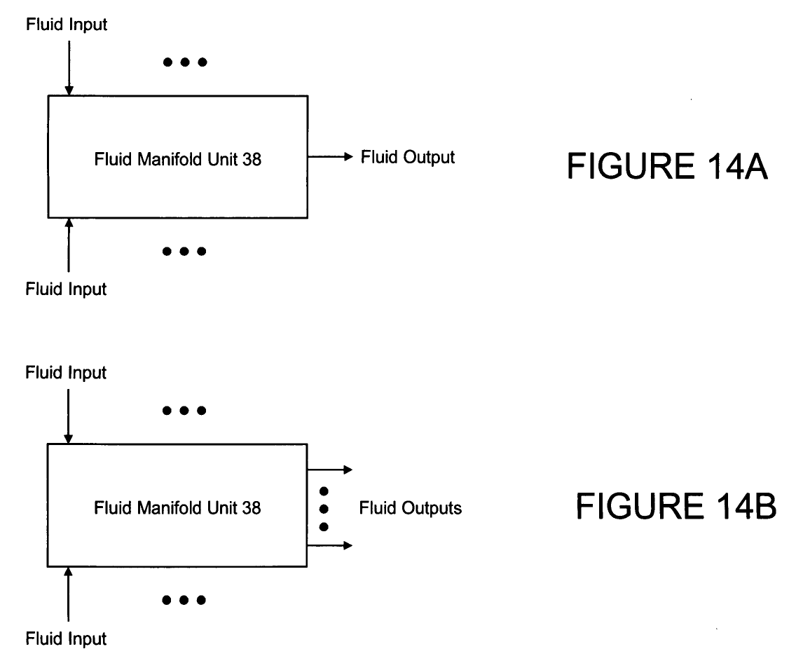

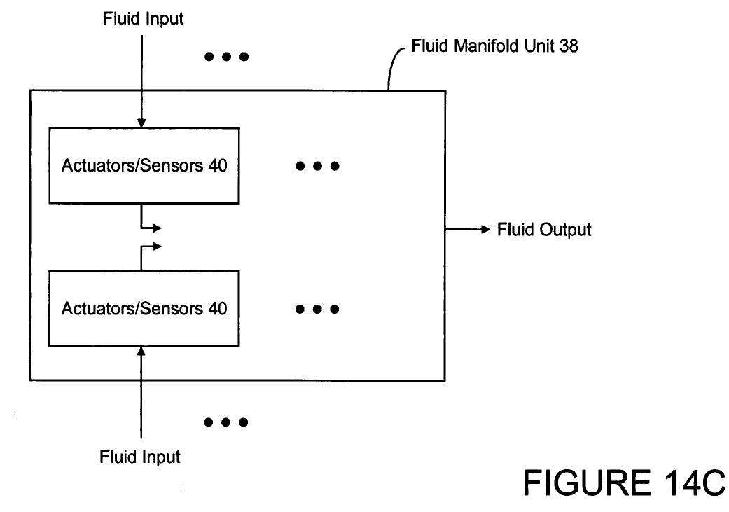

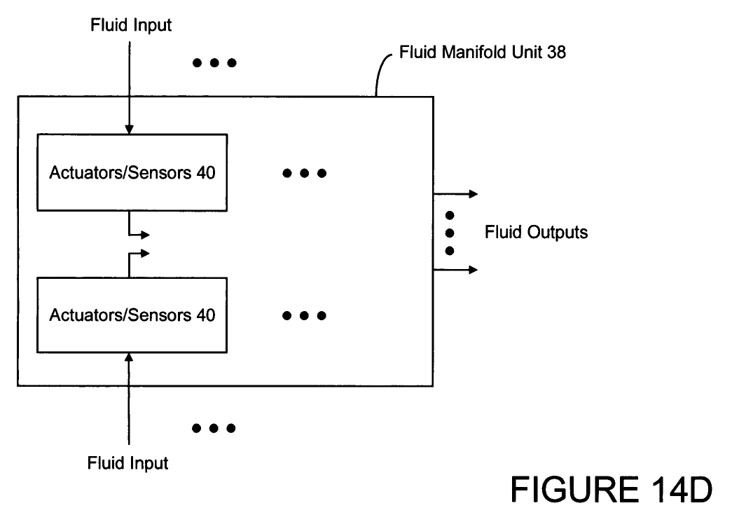

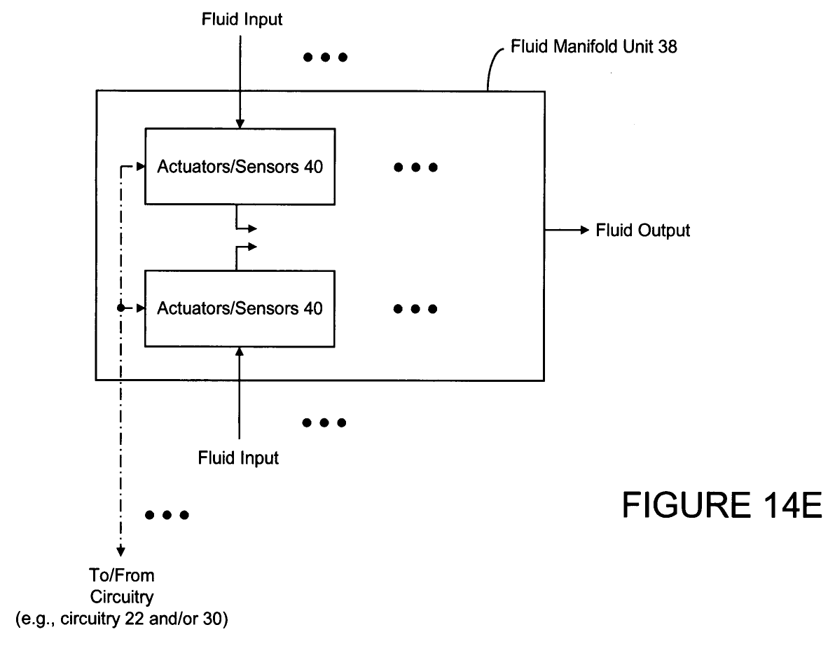

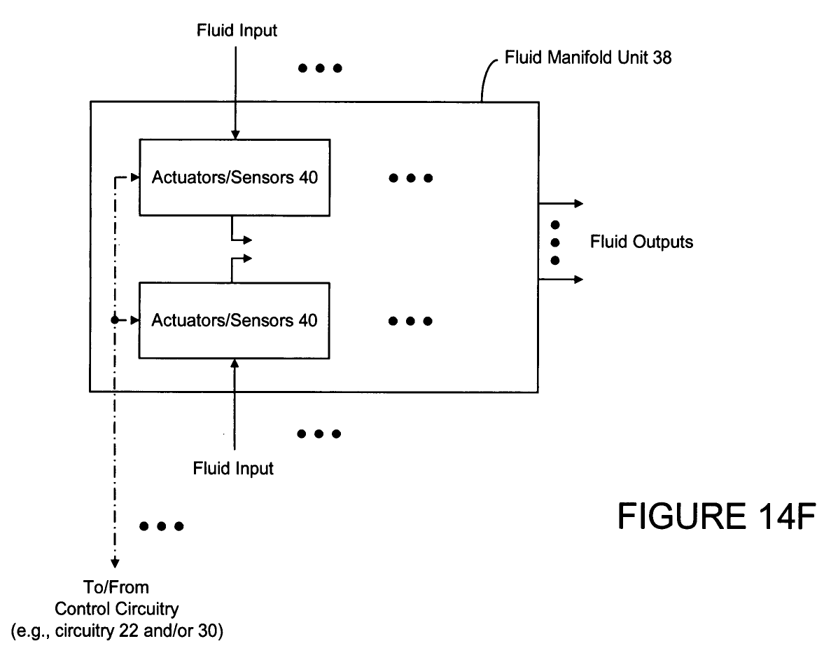

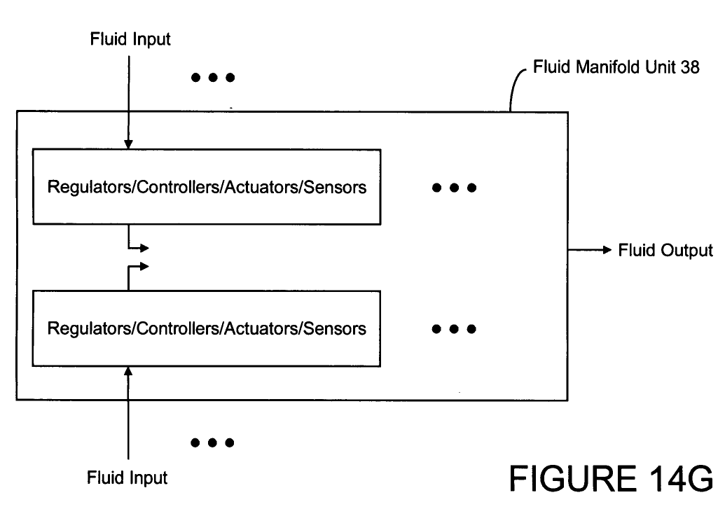

For example, with reference to FIGS. 14A and 14B, fluid manifold unit 38 may include one or more fluid outputs. In this regard, fluid from a plurality of inputs may be individually and controllably routed and/or provided to the one or more fluid outputs. The fluid paths within the fluid manifold unit may be fixed and/or configurable (for example, in situ). In this way, fluid from the one or more interface units 14 and/or fluid storage units 16 may be routed to one or more fluid outputs (for example, of one or more monitoring unit(s) 12).

Notably, the fluid manifold unit 38 may include sensors and/or actuators (or valves, for example, check, shut-off and/or distributing valves) 40 to implement the routing, control, management and sensing techniques described and/or illustrated herein. (See, for example, FIGS. 14C-14F). The sensors may be flow sensors, flow rate sensors, temperature sensors, pressure sensors and/or leak sensors. The valves may be electrically controlled (for example, by circuitry 22, circuitry 30 and/or external circuitry) and/or manually controlled (for example, via the user/operator).

The fluid manifold unit 38 may also include a regulator or controller (for example, a pressure regulator and/or mass flow controller) in order to regulate, control and/or reduce the delivery pressure and/or flow rate of the fluid to an acceptable, desirable or predetermined level. The regulator or controller may be disposed in the fluid input of manifold unit 38. (See, for example, FIG. 14G). The regulator or controller may be electrically controlled (for example, by circuitry 22, circuitry 30 and/or external circuitry) and/or manually controlled (for example, via the user/operator).

Moreover, under those circumstances where fluid from the one or more interface units 14 and/or fluid storage units 16 are advantageous to provide a sufficient flow requirement, fluid manifold unit 38 may include regulators to manage the delivery pressure of the fluid to output and/or monitoring unit 12. Notably, this may be obtained by internal fluid regulation in interface unit 14 (for example, FIG. 14G) or by communicating to fluid storage unit(s) 16 of the pressure required for proper control. Indeed, in one exemplary embodiment, fluid storage unit(s) 16 may be controlled to output the same pressure. In another exemplary embodiment, the fluid storage unit(s) 16 may be controlled by a method comparable to pulse-width-modulation, where interface unit(s) 14 and/or fluid storage unit(s) 16 having varying pressure outputs providing the desired average flow is obtained from each of the respective interface unit(s) 14 and/or fluid storage unit(s) 16.

In another aspect, the present inventions are directed to a system and method of filling, refilling, distributing, allocating and/or dispensing one or more such mobile fluid storage units (for example, portable and/or transportable between a plurality of locations) which contain or are capable of containing one or more fluids (for example, liquid, gas and/or gas vapor forms of oxygen, nitrogen, carbon dioxide, hydrogen, and/or propane). In one embodiment of this aspect, the present inventions include a refill station unit to fill and/or refill (hereinafter collectively “refill”) one or more fluid storage units with a predetermined or selectable fluid. In one embodiment, the refill station unit may provide fluid to the interface unit for storage into the associated fluid storage unit based on data provided by the interface unit. The data may be one or more operating parameters of the interface unit and/or fluid storage unit associated therewith. For example, the one or more operating parameters may be the current state of fill of the fluid storage unit.

In addition thereto, or in lieu thereof, the data may be unique-type data which is specific to the interface unit and/or fluid storage unit. For example, such data may include an associated serial number, the fluid storage capacity of the fluid storage unit, number of fill or refills (if applicable), the storage characteristics of the fluid (for example, pressure), and/or data pertaining to the date of certification and/or recertification, type of fluid to be stored in the fluid storage unit, and/or certain “fixed” operating parameters thereof (for example, delivery/output pressure of the fluid).

As such, the refill station unit, based on the data provided thereto by the interface unit, provides the appropriate and/or predetermined fluid under suitable, appropriate and/or predetermined conditions. Moreover, refill station unit may visually and/or audibly provide data pertaining to when the fluid storage unit was certified and/or is to be or should have been recertified. Where the fluid storage unit is overdue with respect to recertification, the refill station unit may take appropriate action including, for example, providing audible and visual alerts to the user/operator and/or prohibiting or preventing the fluid storage unit from being filled with one or more of the fluids.

In one embodiment, the user may instruct the refill station unit on the amount of fluid to provide including an amount less than that required to entirely refill the storage unit. Upon providing the predetermined amount of fluid, in one embodiment, the refill station unit may return the user/operator the same interface unit and fluid storage unit. In addition thereto, the refill station unit may provide updated parameter data to the interface unit in order to reflect the “new” one or more operating parameters of the interface unit and/or fluid storage unit. For example, a new operating parameter may be a new state of fill based on the previous state of fill (for example, as stored in the memory of the interface unit) and the amount of fluid provided by the refill station unit to the fluid storage unit. Such “new” operating parameter data may be stored in memory in the interface unit.

In another embodiment, the refill station unit may automatically provide an amount of fluid required to entirely refill the storage unit, based on data provided to the refill station unit by the interface unit. Upon providing the appropriate amount of fluid, in one embodiment, the refill station unit may return the user/operator the same interface unit and fluid storage unit. Again, in addition thereto, the refill station unit may provide updated parameter data to the interface unit in order to reflect the “new” one or more operating parameters of the interface unit and/or fluid storage unit. Such data may be stored in the memory of the interface unit.

In addition to data provided to the refill station unit by the interface unit associated with the fluid storage unit, or in lieu thereof, the refill station unit may determine the type of fluid to be provided to the fluid storage unit using a “unique” or “keyed” fluid interface (for example, a “unique” or “keyed” valve assembly). In this regard, the fluid interface on the interface unit and/or the fluid storage unit (for example, the valve assembly) may be representative of or indicative of the type of fluid stored in the fluid storage unit and/or certain operating parameters thereof (for example, the delivery/output pressure of the fluid). The fluid interface on the refill station unit may include a plurality of mating assemblies, each of which is specific to one or more types of fluids. In this embodiment, the refill station unit may detect/determine the type of fluid stored in the fluid storage unit via the “unique” or “keyed” fluid interface and, based on the intended use of the fluid, determine whether to output or provide the fluid to the fluid storage unit.

The user may select the type of fluid to be provided to the fluid storage unit. In this embodiment, the user instructs or controls the refill station unit to provide a certain fluid (which may be one type of fluid or a mixture of different types of fluids) to the fluid storage unit. For example, the refill station unit may “mix” multiple gases from different refilling sources to store a gas mixture in the fuel storage unit. Notably, the refill station unit may provide to and/or store in circuitry in the monitoring unit and/or interface unit (for example, memory) one or more details or parameters of the mixture (for example, the percentages of one or more of the fluids).

Where the fluid storage unit previously stored a fluid different from the fluid to be provided, the refill station unit may “purge” the fluid storage unit prior to providing the “new” fluid to the fluid storage unit. The refill station unit may then provide data to the interface unit which reflects the unique characteristics of the fluid storage unit (for example, the type of fluid contained therein, the amount of fluid, and/or the storage characteristics including pressure of the fluid).

In another set of embodiments, the refill station unit may accept an interface unit and associated fluid storage unit immediately provide the user a “replacement” interface unit and associated fluid storage unit. Thereafter, the refill station unit, based on the data provided thereto by the interface unit, may refill (completely or to a predetermined level) the fluid storage unit provided by the user.

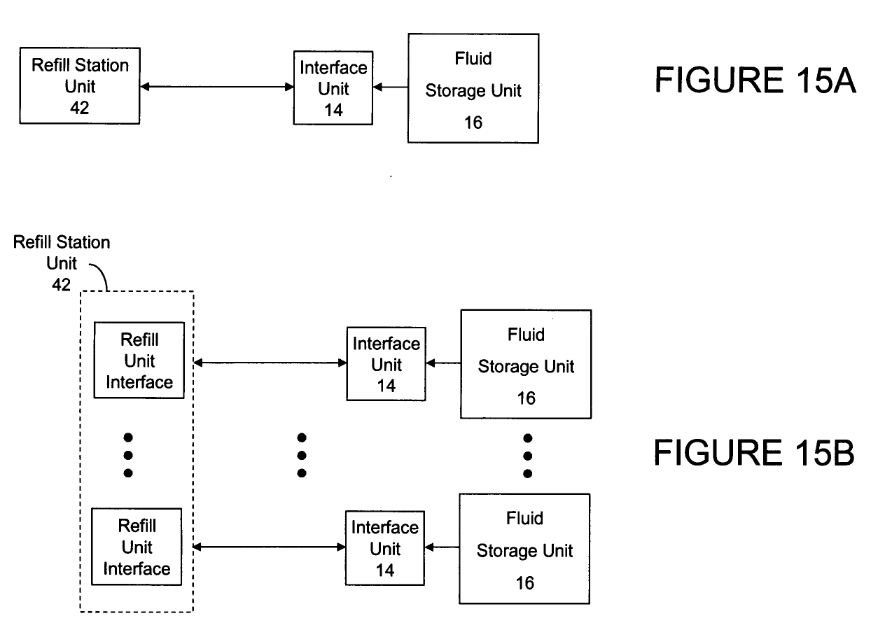

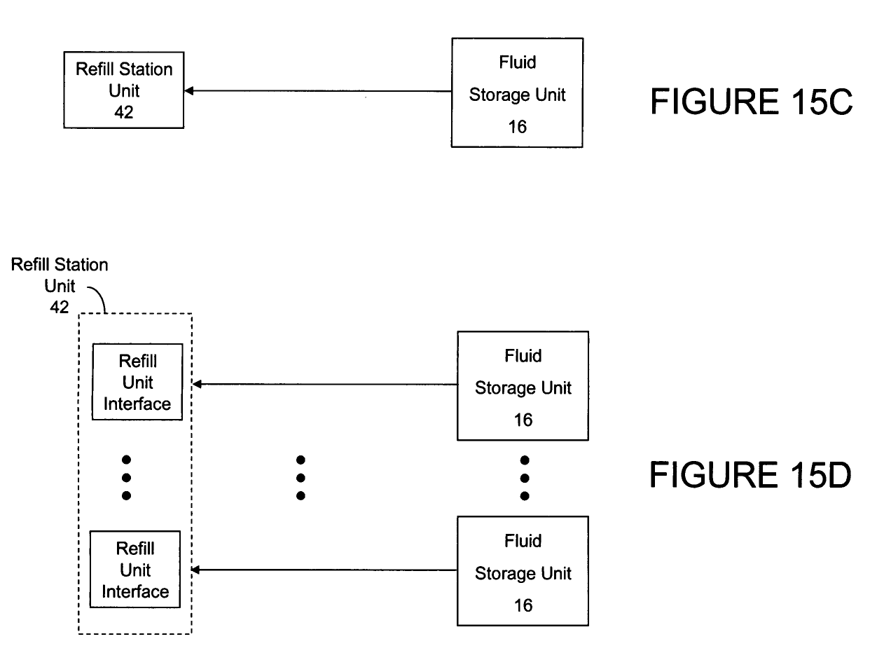

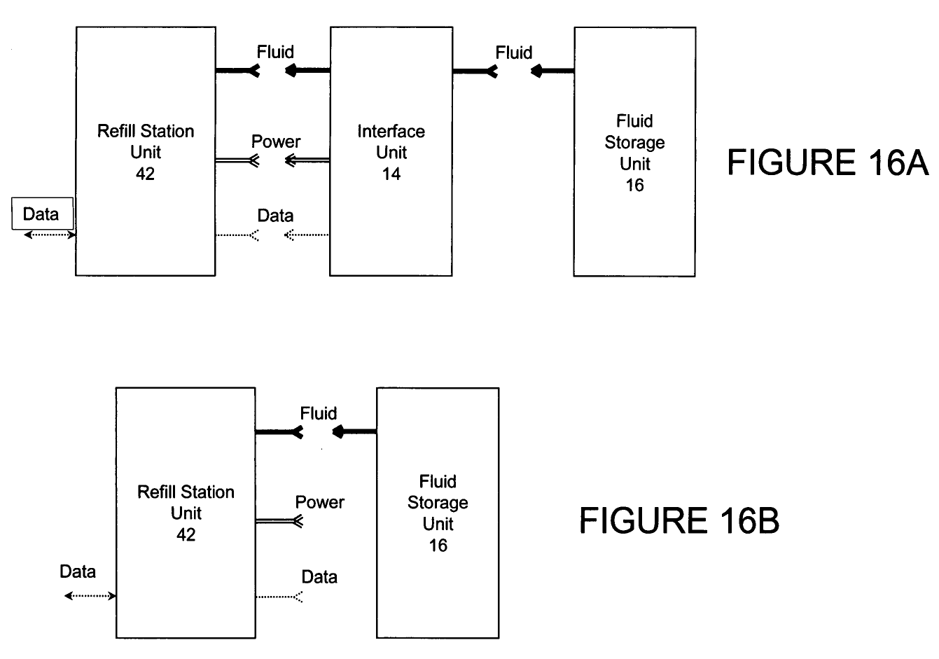

With reference to FIGS. 15A, 15B and 16A, in at least one embodiment, refill station unit 42 interfaces with one or more interface units 14. The refill station unit 42 includes suitable reciprocal mechanical, electrical and fluid interfaces to connect to the interfaces of one or more interface units 14. After connected, refill station unit 42 is capable of receiving data which is representative of one or more operating conditions or parameters of interface unit 14 and/or fluid storage unit 16. In addition thereto, or in lieu thereof, refill station unit 42 is capable of receiving “unique” data of interface unit 14 and/or fluid storage unit 16.

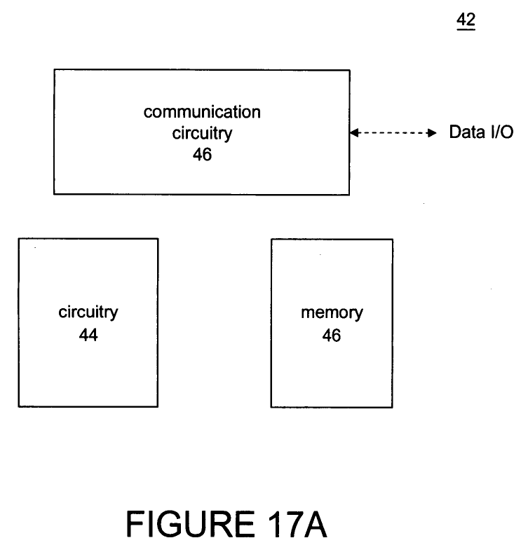

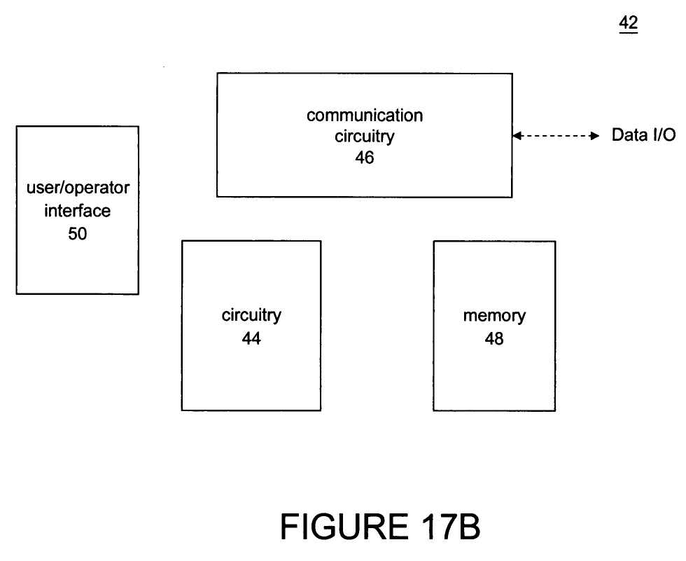

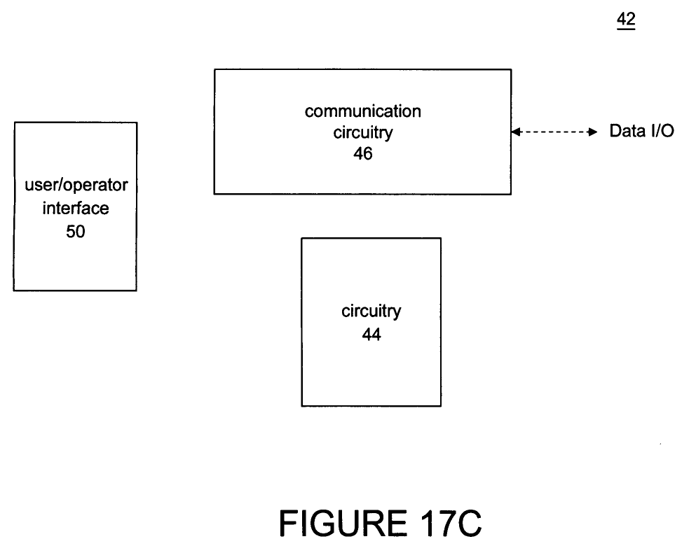

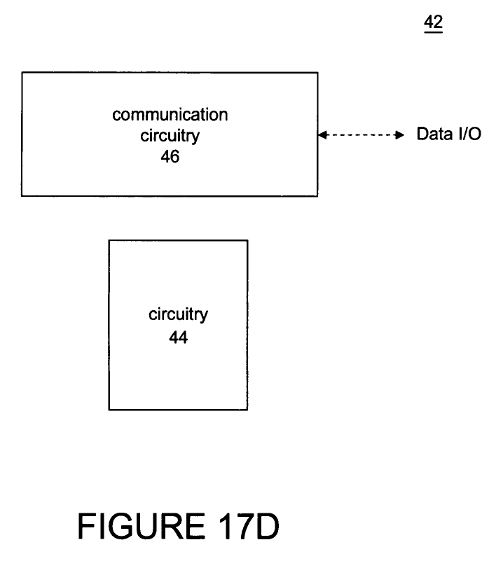

With reference to FIGS. 17A-17D, refill station unit 42 may include circuitry 44 to determine a refill process, for fluid storage unit 16, using data which is representative of the one or more operating parameters of interface unit 14 and/or fluid storage unit 16. The circuitry 44 may include a microprocessor, microcontroller, state machine, discrete logic, and/or programmable gate array (for example, field programmable gate array). In one embodiment, circuitry 44 (or circuitry 30 of interface unit 14) may determine an amount of fluid required to achieve the desired or predetermined fill conditions of fluid storage unit 16 (for example, as preset or predefined or as set or selected by the user). Based thereon, refill station unit 42 may provide fluid to the fluid storage unit 16.

During the refill process, circuitry 44 may intermittently, continuously, periodically, on the occurrence of an event (whether an internal event or an external event) and/or at predetermined time, provide updated parameter data to interface unit 14 to reflect the “new” one or more operating parameters of interface unit 14 and/or fluid storage unit 16 (for example, data that reflects the new fill state of fluid storage unit 16). Such data may be stored in the memory of the interface unit (see, for example, FIG. 6A). Notably, in addition thereto, or in lieu thereof, circuitry 44 may employ or use data provided by/from sensing and/or measuring device (for example, one or more flow meters to measure and/or determine the rate of flow of fluid, clock circuitry, temperature and/or pressure data provided by sensors disposed on/in and/or associated with any portion of system 10).

The refill station unit 42 may provide the data which is representative of one or more operating parameters of interface unit 14 and/or fluid storage unit 16 to external circuitry (for example, circuitry disposed at a remote location, such as, circuitry at a central station and/or fluid supplier/provider). Notably, refill station unit 42 may include wired and/or wireless communication circuitry 46 to provide the data via wired and/or wireless techniques. Indeed, refill station unit 42 may receive or obtain software and/or firmware (whether new or upgrades) via communication circuitry 46 from local or remote location(s). For example, where a new fluid or fluid mixture, appropriate data may be provided to refill station unit 42.

Notably, refill station unit 42 may also output or provide data which is representative of the physical location of refill station unit 42 and/or monitoring unit 12, interface unit 14 and/or fuel storage unit 16 (when engaged with refill station unit 42). The refill station unit 42 may include circuitry (for example, circuitry discrete from or integrated into circuitry 44 and/or 46) to provide for example, a local station, central station, fluid supplier, and/or user/operator (whether such user/operator is located locally or remotely) the physical location of refill station unit 42. Such circuitry may correlate the data with mapping-type software to illustrate the physical location. In one embodiment, circuitry (whether located locally or remotely from refill station unit 42) may determine, schedule, plan and/or calculate a route or schedule for the delivery of fluid for refill station unit 42 and/or new fluid storage units 16 to replenish the consumed units and/or route the filling vehicle to fill the fluid storage units that are relatively fixed.

With reference to FIGS. 17A and 17B, refill station unit 42 may include memory 48 (for example, dynamic or static memory (whether discrete or integrated with the circuitry) such as SRAM, DRAM, ROM, PROM, EPROM and/or EEPROM) to receive and store data or information which is representative of the one or more operating parameters (for example, current or historical type information). The memory 48 may receive and store data which uniquely or specifically identifies (from the perspective of one or more other storage units) interface unit 14 and/or fluid storage unit 16. Notably, all forms or types of memory, whether now known or later developed, are intended to fall within the scope of the present inventions. Indeed, memory 48 may be integrated into circuitry 44 and/or circuitry 46.

The refill station unit 42 may include a user/operator interface 50, for example, a display (for example, an LCD or LED display) to visually display information which is representative of one or more of the operating parameters of interface unit 14 and/or fluid storage unit 16. (See, for example, FIGS. 17B and 17C). In addition thereto, or in lieu thereof, user/operator interface 50 may include an audible indicator and/or an input mechanism (for example, one or more button switches or keypad) to receive user/operator inputs, data, commands and/or instructions. The refill station unit 44 may include a power source (for example, local power source such as a battery or fuel cell) or receive or generate power (e.g., 24V, 110V or 220V) for the circuitry/devices/components of refill station unit 42 and/or interface unit 14.

It should be noted that circuitry 44, communication circuitry 46, and/or memory 48 may be comprised of discrete component(s) or may be integrated. Indeed, such circuitry and/or memory may reside on or in an integrated circuit that performs other operations, for example, processing circuitry (such as a microcontroller or microprocessor).

Notably, although illustrated as a one-one interface unit fluid storage unit pair, any of the configurations described and/or illustrated herein may be employed in conjunction with the refill station unit. For example, the interface unit may couple to a plurality of fluid storage units 16 in a plurality of different configurations (see, for example, FIGS. 10A-10E) and, in conjunction with the refill station unit, refill one or more of the fluid storage units associated therewith.

With reference to FIGS. 15C, 15D and 16B, in another embodiment, refill unit 42 is connected directly to fluid storage unit 16. In this embodiment, refill station unit 42 may determine the type of fluid to be provided to fluid storage unit 16 using a “unique” or “keyed” fluid interface (for example, a “unique” or “keyed” valve assembly). In this regard, the fluid interface on fluid storage unit 16 (for example, the valve assembly) may be representative of or indicative of the type of fluid stored in fluid storage unit 16 and/or certain operating parameters thereof (for example, the delivery/output pressure of the fluid). The fluid interface on the refill station unit may include a plurality of mating assemblies, each of which is specific to one or more types of fluids. In this embodiment, the refill station unit may detect/determine the type of fluid stored in the fluid storage unit via the “unique” or “keyed” fluid interface and, based on the intended use of the fluid, determine whether to output or provide the fluid to the fluid storage unit.

The refill station unit 42 may include a thermal management unit (for example; a device/unit which provides or removes heat) to control or maintain the operating temperature of one or more of the components of the interface unit 14 and/or fluid storage unit 16. For example, the system may include a hydrogen-powered catalytic heater, fan and heat exchanger for keeping metal hydride canisters warm and operable in cold climates in low power draw conditions. In short, such thermal management unit may enable, facilitate and/or expedite the filling or refilling operation. Any type or form of thermal management or exchange unit and/or technique, whether now known or later developed, is intended to fall within the scope of the present inventions.

The refill station unit 42 may include or have access to one or more refill fluid storage to contain/store one or more pressurized or non-pressurized fluids which are used to fill or refill the fluid storage unit(s) 16. Such fluid(s) may be stored in, for example, solid, liquid, gas and/or gas vapor forms in, for example, a conventional size gas bottle or cylinder (such as a K-bottle size cylinder) or a storage tank. The refill fluid storage may be mobile (for example, portable and/or transportable between a plurality of locations) or immobile (for example, permanently or semi-permanently fixed in a predetermined location). The fluid(s) may be, for example, oxygen, nitrogen, carbon dioxide, hydrogen, alcohol and/or propane. Where the refill fluid storage contains/stores a pressurized fluid it may be advantageous to employ a pressure regulator to establish and/or maintain a suitable, desired and/or predetermined delivery pressure of the fluid (in relation to the interface unit). Moreover, refill station unit 42 may include a mass flow controller that controls, provides and/or determines the rate of deliver of the fluid to fluid storage unit 16. The pressure regulator and/or the mass flow controller may be electrically controllable which allows refill station unit 42 to control the flow on a real time basis and/or in response to the operator/user request or instruction.

The refill station unit 42 may “mix” multiple fluids from different refill fluid storage sources and provide the fluid to fuel storage unit 16 as a fluid mixture. In this regard, refill station unit 42 may also include mechanisms, devices and/or circuitry (for example, distributing valves, mass flow controller, flow meters, pressure regulators and control circuitry) to “mix” (for example, in controlled amounts) two or more of the fluids to provide a “compound” fluid to the fluid storage unit(s) 16 based on the fluids in one or more of refill fluid storage sources. In this embodiment, refill station unit 42 may provide a compound fluid (based on the fluids in two or more of the fluid storage units) and monitor, control, manage and/or measure, individually for each fluid storage unit, the monitor the amount of fluid dispensed, the rate of fluid consumption, the rate of flow of fluid, and/or the time (or estimation thereof) remaining until all (or a predetermined amount) of the fluid is dispensed.

Notably, refill station unit 42 may provide to and/or store in circuitry in monitoring unit 12 and/or interface unit 14 (for example, memory) one or more details or parameters of the mixture (for example, the percentages of one or more of the fluids). For example, memory 34 in interface unit 14 may store such details for later access by external circuitry and/or the under/operator.

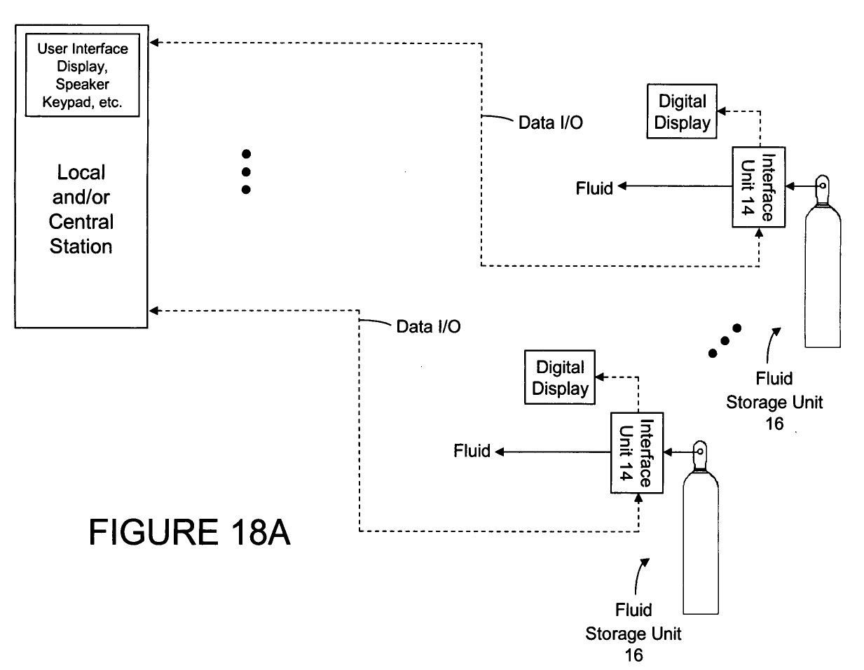

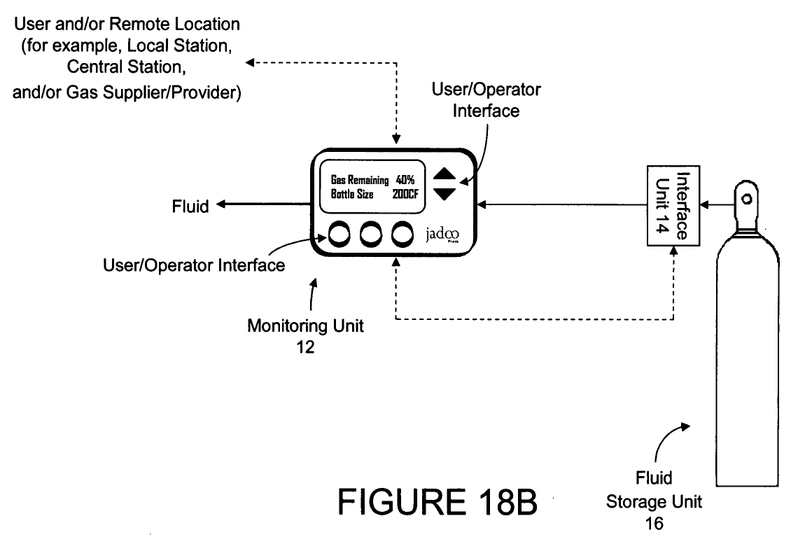

There are many inventions described and illustrated herein. The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, many of those permutations and combinations will not be discussed separately herein. (See, for example, FIGS. 18A and 18B).

While certain embodiments, features, materials, configurations, attributes and advantages of the inventions have been described and illustrated, it should be understood that many other, as well as different and/or similar embodiments, features, materials, configurations, attributes, structures and advantages of the present inventions that are apparent from the description, illustration and claims are possible by one skilled in the art (after consideration and/or review of this disclosure). As such, the embodiments, features, materials, configurations, attributes, structures and advantages of the inventions described and illustrated herein are not exhaustive and it should be understood that such other, similar, as well as different, embodiments, features, materials, configurations, attributes, structures and advantages of the present inventions are within the scope of the present inventions.

Each of the aspects of the present inventions, and/or embodiments thereof, may be employed alone or in combination with one or more of such aspects and/or embodiments. For the sake of brevity, those permutations and combinations will not be discussed separately herein. As such, the present inventions are not limited to any single aspect or embodiment thereof or to any combinations and/or permutations of such aspects and/or embodiments. Moreover, each of the aspects of the present inventions, and/or embodiments thereof, may be employed alone or in combination with one or more of such other aspects and/or embodiments.

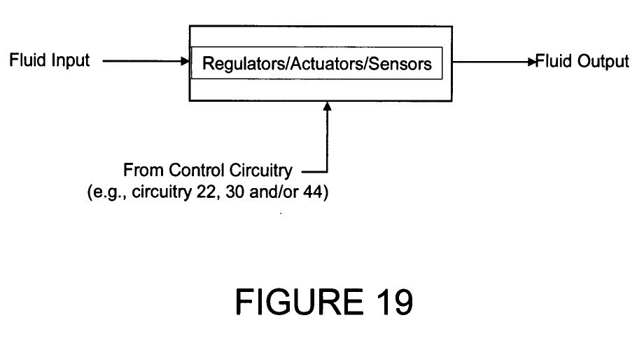

For example, the monitoring unit, the interface unit, the fluid storage unit and/or the refill station unit may include one or more regulators, actuators and/or sensors. Such one or more regulators, actuators and/or sensors may be, for example, controllable by circuitry in the unit associated therewith or in any of the monitoring, interface and/or refill station units. (See, for example, FIG. 19).

Notably, as mentioned above, the circuitry in monitoring unit 12 and/or interface unit 14 monitors, controls, manages and/or measures one or more operating parameters of fluid storage unit 16. Such circuitry, and the operations performed thereby, may be disposed exclusively in/on monitoring unit 12 or interface unit 14. Alternatively, such circuitry, and the operations performed thereby, may be distributed in one or more of monitoring units 12 and/or interface units 14, and/or external circuitry. All permutations and combinations are intended to fall within the scope of the present inventions.

Similarly, the circuitry in the refill station unit, and the operations performed thereby, may be disposed exclusively in/on refill station unit 42 and/or monitoring unit 12 and/or interface unit 14. Alternatively, such circuitry, and the operations performed thereby, may be distributed in one or more of refill station unit, monitoring unit and/or interface unit. All permutations and combinations are intended to fall within the scope of the present inventions.

For example, the monitoring unit and/or interface unit may be coupled to the refill station unit to monitor, control and/or manage the refill processes (for example, the fluid storage into the fluid storage unit). For example, in one embodiment, where the fluid storage unit is a large fixed tank of, for example, propane (for example, which is used for household heating), when the tank is being refilled by, for example, a tank trailer which does not have one, some or all of the capabilities or operability discussed above, the monitoring unit and/or interface unit may be employed to monitor, control and/or manage the refill processes including, in this embodiment, the amount of fluid being filled into the large fixed tank.

The communication circuitry in monitoring unit 12 and/or interface unit 14 may communicate with remote external devices and/or a remote user/operator. The communication circuitry may include, for example, cellular, satellite, line-of-sight RF, optical or internet-based telemetry. The discussions above with respect to the external circuitry and the user/operator are applicable to the embodiments including communication circuitry to provide communication with remote external devices and/or a remote user/operator. For the sake of brevity, such discussions will not be repeated.

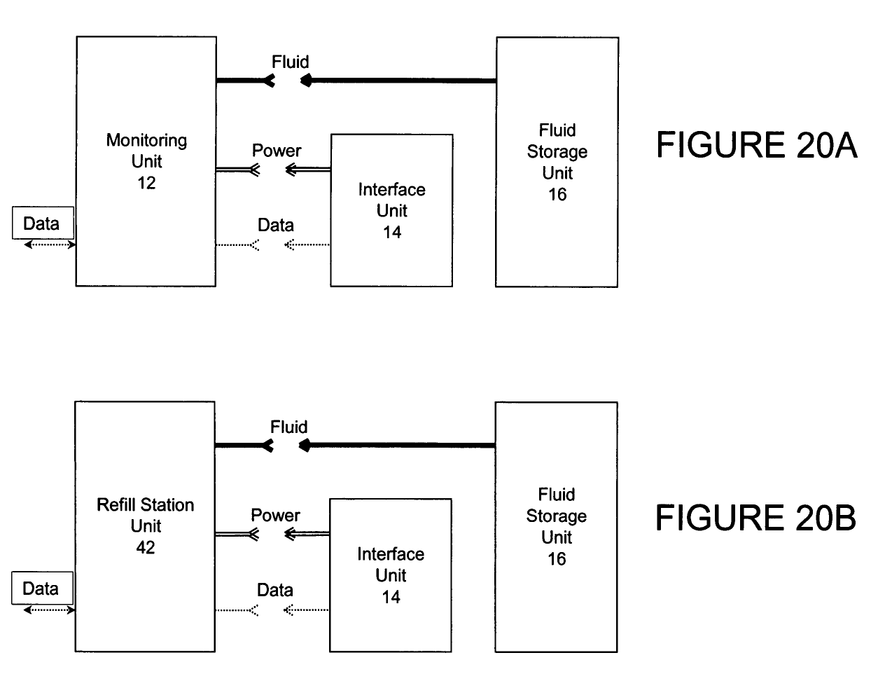

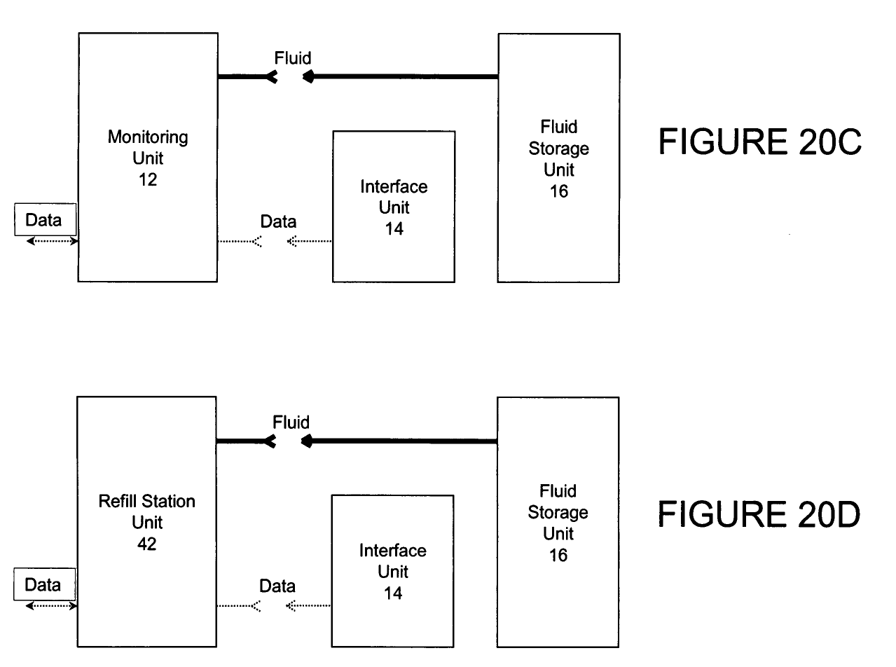

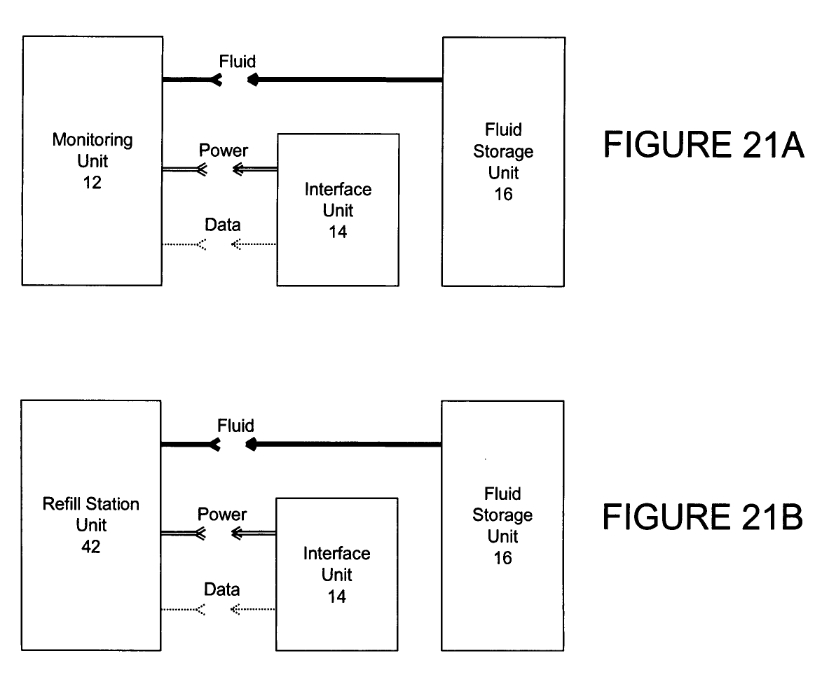

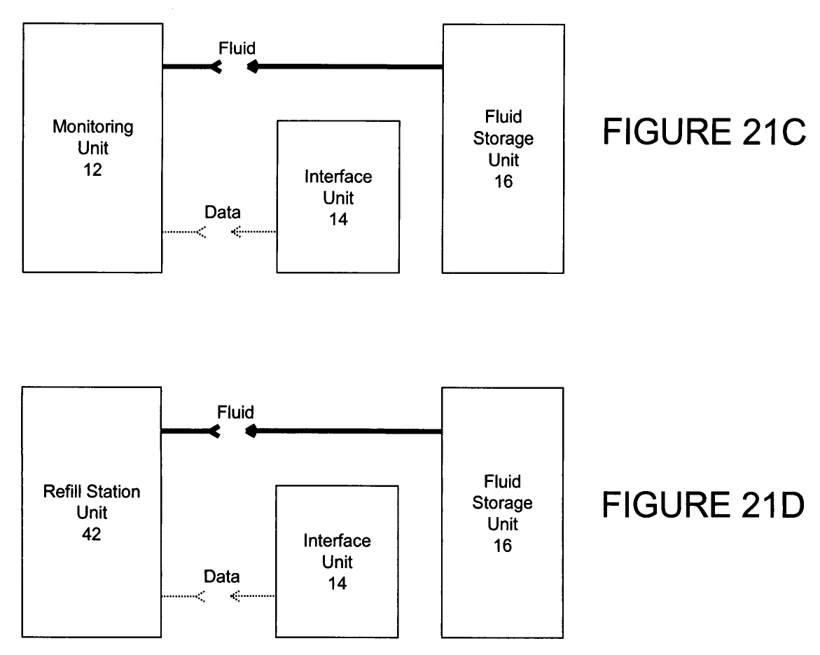

Notably, although the interface unit and the fluid storage unit are described and illustrated as including certain circuitry, devices and/or mechanisms, and/or performing certain operations and/or processes, one or more of such circuitry, devices and/or mechanisms, and/or operations and/or processes may be omitted and/or contained or distributed among the combination. For example, the interface unit may include circuitry and/or memory that is fixed to the fluid storage unit and the output of the fluid storage unit is connected directly to the monitoring unit or the refill station unit. (See, for example, FIGS. 20A-20D and 21A-21D). Notably, the interface configurations of FIGS. 20A-20D and 21A-21D may be implemented according to any of the embodiments discussed above. For the sake of brevity, those discussions will not be repeated.

It should be further noted that the term “circuit” means, among other things, a single component (analog or digital) or a multiplicity of components (whether in integrated circuit form or otherwise), which are active and/or passive, and/or analog or digital (or combinations thereof), and which are coupled together to provide or perform a desired operation. The term “circuitry” means, among other things, a circuit (whether integrated or otherwise), a group of such circuits, one or more processors, one or more state machines, one or more processors implementing firmware/software, or a combination of one or more circuits (whether integrated or otherwise), one or more state machines, one or more processors, and/or one or more processors implementing firmware/software.

Moreover, as noted above, the fluid storage unit may contain/store one or more pressurized or non-pressurized fluids. Such fluid(s) may be stored in, for example, solid, liquid, gas and/or gas vapor forms in, for example, a conventional or unconventional size gas bottle or cylinder (such as a T- or K-bottle size cylinder) or a storage tank. The fluid storage unit may be mobile (for example, portable and/or transportable between a plurality of locations) or immobile. The term “fluid container” means, among other things, any size bottle, cylinder or tank.

The above embodiments of the present inventions are merely exemplary embodiments. They are not intended to be exhaustive or to limit the inventions to the precise forms, techniques, materials and/or configurations disclosed. Many modifications and variations are possible in light of the above teaching. It is to be understood that other embodiments may be utilized and operational changes may be made without departing from the scope of the present inventions. As such, the foregoing description of the exemplary embodiments of the inventions has been presented for the purposes of illustration and description. It is intended that the scope of the inventions not be limited to the description above.

What is claimed is:

1. A system to monitor, control and/or manage the output of at least one fluid, the system comprising:
a first fluid storage unit including a first fluid container to store a fluid;
a first interface unit, secured to the first fluid storage unit, to monitor the amount of fluid in the first fluid container, the first interface unit comprising:
an electrical interface;
memory to store data which is representative of (i) the type of fluid in the first fluid container and (ii) the amount of fluid in the first fluid container; and
circuitry to monitor the amount of fluid in the first fluid container; and
monitoring unit, fluidically coupled to the first fluid storage unit to receive and output the fluid contained therein, the monitoring unit comprising:
a fluid interface to output fluid of the first fluid storage unit;
an electrical interface coupled to the electrical interface of the first interface unit to receive data which is representative of an amount of fluid in the first fluid container; and
circuitry to communicate to a remote location data which is representative of (i) the physical location of first fluid storage unit and (ii) the amount of fluid in the first fluid container.

2. The system of claim 1 wherein the first interface unit includes a display to the amount of fluid in the first fluid container.

3. The system of claim 1 wherein:
the electrical interface of the monitoring unit receives data which is representative of the type of fluid in the first fluid container; and
the circuitry in the monitoring unit, using the data which is representative of the type of fluid in the first fluid container, evaluates whether to output fluid.

4. The system of claim 1 further including:
a second fluid storage unit including a second fluid container to store a fluid wherein the second fluid storage unit is coupled to the first interface unit; and
wherein the memory of the first interface unit stores data which is representative of (i) the type of fluid in the second fluid container and (ii) the amount of fluid in the second fluid container; and wherein circuitry of the first interface unit monitors the amount of fluid in the second fluid container.

5. The system of claim 1 wherein the monitoring unit includes a display to the amount of fluid in the first fluid container.

6. The system of claim 1 wherein the monitoring unit includes a user/operator input to control the monitoring unit.

7. The system of claim 1 further including:
a second fluid storage unit including a second fluid container to store a fluid; and
a second interface unit, secured to the second fluid storage unit, to monitor the amount of fluid in the second fluid container, the second interface unit comprising:
an electrical interface;
memory to store data which is representative of (i) the type of fluid in the second fluid container and (ii) an amount of fluid in the second fluid container;
circuitry to monitor the amount of fluid in the second fluid container; and
wherein the monitoring unit is fluidically coupled to the second fluid storage unit to receive and output the fluid contained therein, and wherein:
the electrical interface is coupled to the electrical interface of the second interface unit to receive data which is representative of an amount of fluid in the second fluid container; and
the circuitry communicates to a remote location data which is representative of (i) the physical location of second fluid storage unit and (ii) the amount of fluid in the second fluid container.

8. The system of claim 7 wherein the monitoring unit includes a display to the amount of fluid in the second fluid container.

9. The system of claim 7 wherein the monitoring unit includes a user/operator input to control the monitoring unit.

10. A system to monitor, control and/or manage the output of at least one fluid, the system comprising:
a first fluid storage unit including a first fluid container to store a fluid;
a first interface unit, secured to the first fluid storage unit, the first interface unit comprising:
an electrical interface;
memory to store data which is representative of (i) the type of fluid in the first fluid container and (ii) the amount of fluid in the first fluid container; and
monitoring unit, fluidically coupled to the first fluid storage unit to receive and output the fluid contained therein, the monitoring unit comprising:
a fluid interface to output the fluid of the first fluid storage unit;
an electrical interface coupled to the electrical interface of the first interface unit to receive data which is representative of the amount of fluid in the first fluid container; and
circuitry to monitor the amount of fluid in the first fluid container; and
circuitry to communicate to a remote location data which is representative of (i) the physical location of first fluid storage unit and (ii) the amount of fluid in the first fluid container.

11. The system of claim 10 wherein the first interface unit includes a display to the amount of fluid in the first fluid container.

12. The system of claim 10 wherein the circuitry in the monitoring unit stores data which is representative of the amount of fluid in the first fluid container in the memory of the first interface unit.

13. The system of claim 10 wherein:
the electrical interface of the monitoring unit receives data which is representative of the type of fluid in the first fluid container; and
the circuitry in the monitoring unit, using the data which is representative of the type of fluid in the first fluid container, evaluates whether to output fluid.

14. The system of claim 10 further including:
a second fluid storage unit including a second fluid container to store a fluid wherein the second fluid storage unit is coupled to the first interface unit; and
wherein the memory of the first interface unit stores data which is representative of (i) the type of fluid in the second fluid container and (ii) an amount of fluid in the second fluid container.

15. The system of claim 10 wherein the monitoring unit includes a display to the amount of fluid in the first fluid container.

16. The system of claim 10 wherein the monitoring unit includes a user/operator input to control the monitoring unit.

17. The system of claim 10 further including:
a second fluid storage unit including a second fluid container to store a fluid; and
a second interface unit, secured to the second fluid storage unit, to monitor the amount of fluid in the second fluid container, the second interface unit comprises:
an electrical interface; and
memory to store data which is representative of (i) the type of fluid in the second fluid container and (ii) the amount of fluid in the second fluid container; and
wherein the monitoring unit is fluidically coupled to the second fluid storage unit to receive and output the fluid contained therein, and wherein:
the electrical interface is coupled to the electrical interface of the second interface unit to receive data which is representative of an amount of fluid in the second fluid container;
the circuitry monitors the amount of fluid in the second fluid container; and
the circuitry communicates to a remote location data which is representative of (i) the physical location of second fluid storage unit and (ii) the amount of fluid in the second fluid container.

18. The system of claim 17 wherein the monitoring unit includes a display to the amount of fluid in the second fluid container.

19. The system of claim 17 wherein the monitoring unit includes a user/operator input to control the monitoring unit.
